(19) United States
(12) Patent Application Publication
(10) Pub. No.: US 2014/0108359 A1
(43) Pub. Date: Apr. 17, 2014

(54) SCALABLE DATA PROCESSING FRAMEWORK FOR DYNAMIC DATA CLEANSING

(71) Applicants: CHEVRON U.S.A. INC., San Ramon, CA (US); UNIVERSITY OF SOUTHERN CALIFORNIA, Los Angeles, CA (US)

(72) Inventors: Farnoush Banaei-Kashani, Los Angeles, CA (US); Yingying Zheng, Los Angeles, CA (US); Si-Zhao Qin, Los Angeles, CA (US); Mohammad Asghari, Los Angeles, CA (US); Mahdi Rahmani Mofrad, Los Angeles, CA (US); Cyrus Shahabi, Los Angeles, CA (US); Lisa A. Brenskelle, San Ramon, CA (US)

(21) Appl. No.: 13/781,623

(22) Filed: Feb. 28, 2013

Related U.S. Application Data
(60) Provisional application No. 61/712,592, filed on Oct. 11, 2012.

(51) Int. Cl. G06F 17/30

(52) U.S. Cl. CPC G06F 17/30303
USPC 707/692

(57) ABSTRACT

Methods and systems for reconstructing data are disclosed. One method includes receiving a selection of one or more input data streams at a data processing framework, and receiving a definition of one or more analytics components at the data processing framework. The method further includes applying a dynamic principal component analysis to the one or more input data streams, and detecting a fault in the one or more input data streams based at least in part on a prediction error and a variation in principal component subspace generated based on the dynamic principal component analysis. The method also includes reconstructing data at the fault within the one or more input data streams based on data collected prior to occurrence of the fault.

### CROSS-REFERENCE TO RELATED APPLICATIONS

The present application claims priority from U.S. Provisional Patent Application No. 61/712,592, filed on Oct. 11, 2012, the disclosure of which is hereby incorporated by reference in its entirety.

### TECHNICAL FIELD

The present application relates generally to the field of data cleansing. In particular, the present disclosure relates to a scalable data processing framework for dynamic data cleansing.

### BACKGROUND

Oil production facilities are large scale operations, often including hundreds of sensors used to measure pressures, temperatures, flow rates, levels, compositions, and various other characteristics. The sensors included in such facilities may provide a wrong signal, and sensors may fail. Accordingly, process measurements are inevitably corrupted by errors during the measurement, processing and transmission of the measured signal. These errors can take a variety of forms. These can include duplicate values, out of sync values (i.e., values from the same source with different timestamps), null/unknown values, values that exceed data range limits, outlier values, propagation of suspect or poor quality data, and time ranges of missing data due to field telemetry failures. Other errors may exist as well.

The quality of the oil field data significantly affects the oil production performance and the profit gained from using various software for process monitoring, online optimization, and control. Unfortunately, based on the various errors that can occur, oil field data often contain errors and missing values that invalidate the information used for production optimization.

To improve the accuracy of process data, fault detection techniques have been developed to determine when and how such sensors fail. For example, data driven models including principal component analysis (PCA) or partial least squares (PLS) have been developed to monitor process statistics to detect such failures. Furthermore, a Kalman filter can be used to develop interpolation methods for detecting outliers and reconstructing missing data streams.

However, the above existing solutions have drawbacks. For the estimation of a data point at a particular time, Kalman prediction only uses the past data, while Kalman smoothing only uses the future data. Accordingly, if only partial data is available at a particular time, the Kalman prediction arrangement is unavailable. Conversely, a Kalman filter cannot make use of partial information for purposes of data reconstruction. Accordingly, data reconstruction may not be available in cases where data changes over time, and where all data is not available for analysis (e.g., in dynamic systems where data changes rapidly).

Still further challenges exist with respect to data cleansing. For example, existing systems do not provide a system that is configurable for each possible problem in data to be cleansed, or particular types of data, and do not provide a system that is readily scalable to large-scale data collection systems. Additionally, existing systems are implemented within a shell monitoring application program, which limits the scalability of such systems. Additionally, existing commercial efforts do not address temporal and spatial considerations when considering possible sensor failure detection issues.

For the above and other reasons, improvements in detection and addressing errors in dynamic systems are desirable.

### SUMMARY

In accordance with the present disclosure, the above and other issues are addressed by the following:

In a first aspect, a method of reconstructing data is disclosed. The method includes receiving a selection of one or more input data streams at a data processing framework, and receiving a definition of one or more analytics components at the data processing framework. The method further includes applying a dynamic principal component analysis to the one or more input data streams, and detecting a fault in the one or more input data streams based at least in part on a prediction error and a variation in principal component subspace generated based on the dynamic principal component analysis. The method also includes reconstructing data at the fault within the one or more input data streams based on data collected prior to occurrence of the fault.

In a second aspect, a system is disclosed that includes a user interface presented on a display of a computing system and configured to receive a defined data processing configuration, the defined data processing configuration including a selection of one or more input data streams and one or more operations. The system also includes a data processing framework configured to, based on selection of the one or more operations, apply a dynamic principal component analysis model to the one or more input data streams to detecting faults in the one or more input data streams based at least in part on a prediction error and a variation in principal component subspace generated based on the dynamic principal component analysis. The data processing framework is further configured to reconstruct data at the fault within the one or more input data streams based on data collected within a predetermined time from to occurrence of the fault.

In a third aspect, a computer-readable medium is disclosed that has computer-executable instructions stored thereon which, when executed by a computing system, cause the computing system to perform a method for reconstructing data. The method includes receiving a selection of one or more input data streams at a data processing framework, and receiving a definition of one or more analytics components at the data processing framework. The method further includes applying a dynamic principal component analysis to the one or more input data streams, and detecting a fault in the one or more input data streams based at least in part on a prediction error and a variation in principal component subspace generated based on the dynamic principal component analysis. The method also includes reconstructing data at the fault within the one or more input data streams based on data collected prior to occurrence of the fault.

### BRIEF DESCRIPTION OF THE DRAWINGS

FIG. 1 illustrates a system in which the scalable data processing framework for dynamic data cleansing can be implemented in the context of an oil production facility, in an example embodiment;

FIG. 2 illustrates an example method for reconstructing data for a data set having a plurality of data points, according to an example embodiment;

FIG. 3 illustrates an example method for reconstructing dynamic data, according to an example embodiment;

FIG. 4 illustrates a pipelined framework for scalably performing data processing operations including dynamic data cleansing, according to an example embodiment;

FIG. 5 illustrates a high-level workflow of the implementation-level design for the scalable data processing framework disclosed herein;

FIG. 6 illustrates an example user interface for implementing the scalable data processing framework disclosed herein;

FIG. 7 illustrates an example analysis definition user interface for the scalable data processing framework disclosed herein;

FIG. 8 illustrates the example analysis definition user interface of FIG. 7 for the scalable data processing framework disclosed herein, including a defined analysis process for a particular dynamic data set;

FIG. 9 illustrates an example data flow within the scalable data processing framework disclosed herein;

FIG. 10 illustrates example process adapter arrangements useable within the scalable data processing framework disclosed herein;

FIG. 11 illustrates example process adapter and operator definitions useable within the scalable data processing framework disclosed herein;

FIG. 12 illustrates an average process time as a function of a number of tags used, showing scalability of the data processing framework discussed herein;

FIG. 13 illustrates an average process time as a function of a number of plans used, showing scalability of the data processing framework discussed herein;

FIG. 14 illustrates an example chart representing dynamic principal component analysis for a step fault, in an example embodiment of the data cleansing processes discussed herein;

FIG. 15 illustrates an example chart representing principal component analysis for a step fault, in an example embodiment of the data cleansing processes discussed herein;

FIG. 16 illustrates example experimental results for forward data reconstruction in the event that a first of three sensors are missing, in an example illustration of the data cleansing processes discussed herein;

FIG. 17 is a graph of T² indices in example experimental results when a first of three sensors are missing, in an example illustration of the data cleansing processes discussed herein;

FIG. 18 illustrates example experimental results for forward data reconstruction in the event that a second of three sensors are missing, in an example illustration of the data cleansing processes discussed herein;

FIG. 19 is a graph of T² indices in example experimental results when a second of three sensors are missing, in an example illustration of the data cleansing processes discussed herein;

FIG. 20 illustrates example experimental results for forward data reconstruction in the event that a third of three sensors are missing, in an example illustration of the data cleansing processes discussed herein;

FIG. 21 is a graph of T² indices in example experimental results when a third of three sensors are missing, in an example illustration of the data cleansing processes discussed herein;

FIG. 22 illustrates example experimental results for forward data reconstruction in the event that a first and second of three sensors are missing, in an example illustration of the data cleansing processes discussed herein;

FIG. 23 is a graph of T² indices in example experimental results when first and second of three sensors are missing, in an example illustration of the data cleansing processes discussed herein;

FIG. 24 illustrates example experimental results for forward data reconstruction in the event that a first and third of three sensors are missing, in an example illustration of the data cleansing processes discussed herein;

FIG. 25 is a graph of T² indices in example experimental results when first and third of three sensors are missing, in an example illustration of the data cleansing processes discussed herein;

FIG. 26 illustrates example experimental results for forward data reconstruction in the event that a second and third of three sensors are missing, in an example illustration of the data cleansing processes discussed herein;

FIG. 27 is a graph of T² indices in example experimental results when second and third of three sensors are missing, in an example illustration of the data cleansing processes discussed herein;

FIG. 28 illustrates example experimental results for forward data reconstruction in the event that three sensors are missing, in an example illustration of the data cleansing processes discussed herein;

FIG. 29 is a graph of T² indices in example experimental results when three of three sensors are missing, in an example illustration of the data cleansing processes discussed herein;

FIG. 30 illustrates example experimental results for backwards data reconstruction in the event that a first of three sensors are missing, in an example illustration of the data cleansing processes discussed herein;

FIG. 31 illustrates example experimental results for backwards data reconstruction in the event that a second of three sensors are missing, in an example illustration of the data cleansing processes discussed herein;

FIG. 32 illustrates example experimental results for backwards data reconstruction in the event that a third of three sensors are missing, in an example illustration of the data cleansing processes discussed herein;

FIG. 33 illustrates example experimental results for backwards data reconstruction in the event that a first and second of three sensors are missing, in an example illustration of the data cleansing processes discussed herein;

FIG. 34 illustrates example experimental results for backwards data reconstruction in the event that a first and third of three sensors are missing, in an example illustration of the data cleansing processes discussed herein;

FIG. 35 illustrates example experimental results for backwards data reconstruction in the event that a second and third of three sensors are missing, in an example illustration of the data cleansing processes discussed herein; and

FIG. 36 illustrates example experimental results for backwards data reconstruction in the event that three sensors are missing, in an example illustration of the data cleansing processes discussed herein.

### DETAILED DESCRIPTION

As briefly described above, embodiments of the present invention are directed to dynamic data reconstruction based on dynamic data. The systems and methods of the present disclosure provide for data reconstruction that has improved flexibility as compared to the traditional Kalman filter in that they can optionally use partial data available at a particular time. Therefore, the methods discussed herein provide for reconstruction of missing or faulty sensor values in situations that no matter how many sensors are missing or faulty. In some embodiments discussed here, both forward data reconstruction (FDR) and backward data reconstruction (BDR) are used to provide for fault detection and data reconstruction.

In accordance with the following disclosure, the systems and methods herein provide a number of advantages over existing systems. In some embodiments, the systems and methods described herein provide for real-time monitoring and decision making regarding dynamic data, allowing for “on the fly” data cleansing while data is being collected. Additionally, based on the pipelined, modular architecture described in further detail below, the methods and systems described herein are highly scalable to a large number (e.g., hundreds of thousands) of data streams. The systems and methods described herein also are configurable by non-expert users, and can be reused in various contexts and applications. Additionally, as data cleansing operators are developed, they can be integrated into the framework described herein, ensuring that the systems are extensible and comprehensive of various data cleansing issues.

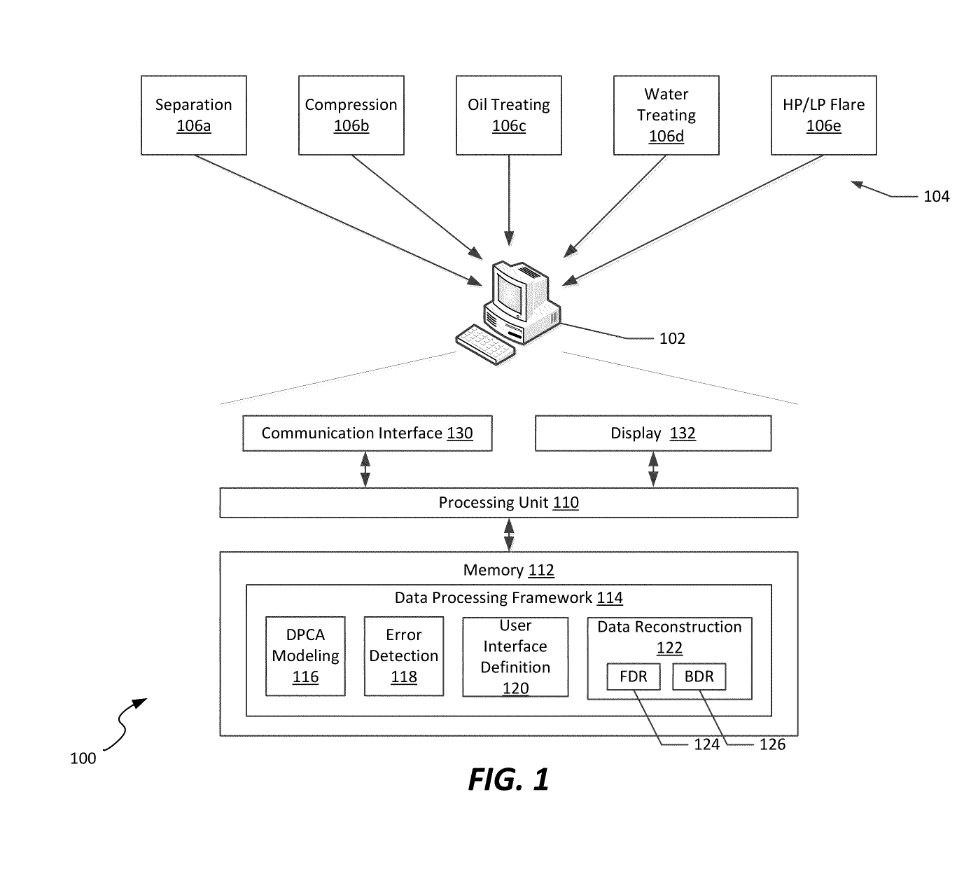

Referring now to FIG. 1, an example system 100 used to implement a scalable data processing framework, as provided by the present disclosure. In particular, the example system 100 integrates a plurality of data streams of different types from an oil production facility, such as an oil field. As illustrated in the embodiment shown, a computing system 102 receives data from an oil production facility 104, which includes a plurality of subsystems, including, for example, a separation system 106a, a compression system 106b, an oil treating system 106c, a water treating system 106d, and an HP/LP Flare system 106e.

The oil production facility 104 can be any of a variety of types of oil production facilities, such as a land-based or offshore drilling system. In the embodiment shown, the subsystems of the oil production facility 104 each are associated with a variety of different types of data, and have sensors that can measure and report that data in the form of data streams. For example, the separation system 106a may include pressure and temperature sensors and associated sensors that test backpressure as well as inlet and outlet temperatures. In such a system, various errors may occur, for example valve stiction or other types of error conditions. The compression system 106b can include a pressure control for monitoring suction, as well as a variety of stage discharge temperature controllers and associated sensors. In addition, the oil treating system 106c, water treating system 106d, and HP/LP Flare system 106e can each have a variety of types of sensors, including pressure and temperature sensors, that can be periodically sampled to generate a data stream to be monitored by the computing system 102. It is recognized that the various system 106a-e are intended as exemplary, and that various other systems could have sensors that are be incorporated into data streams provided to the computing system 102 as well.

In the embodiment shown, the computing system 102 includes a processor 110 and a memory 112. The processor 110 can be any of a variety of types of programmable circuits capable of executing computer-readable instructions to perform various tasks, such as mathematical and communication tasks.

The memory 112 can include any of a variety of memory devices, such as using various types of computer-readable or computer storage media. A computer storage medium or computer-readable medium may be any medium that can contain or store the program for use by or in connection with the instruction execution system, apparatus, or device. In the embodiment shown, the memory 112 stores a data processing framework 114. The data processing framework 114 performs analysis of dynamic data, such as is received in data streams (e.g., from an oil production facility 104), for detecting and reconstructing faults in data.

In the embodiment shown, the data processing framework 114 includes a DPCA modeling component 116, an error detection component 118, a user interface definition component 120, and a data reconstruction component 122.

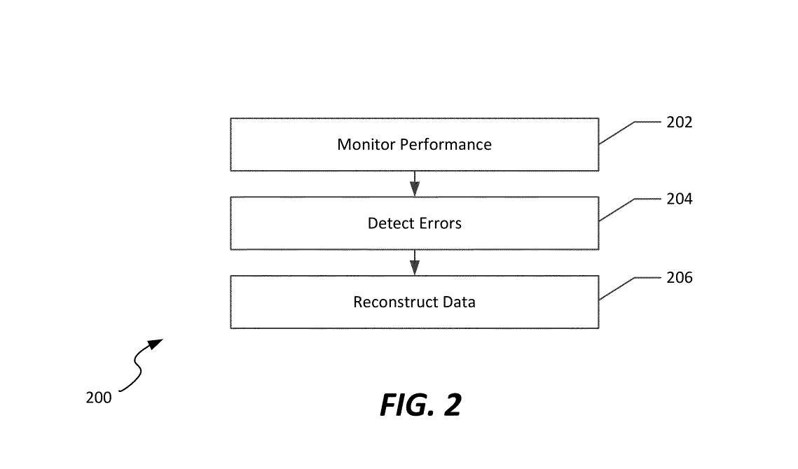

The DPCA modeling component 116 receives dynamic data, for example from a data stream, and performs a principal component analysis on that data, as discussed in further detail below. For example, the DPCA modeling component 116 can perform a principal component analysis using measured variables that are not characterized as input and output variables, but rather are related to a number of latent variables to represent their respective correlations. An example of such analysis is discussed below in connection with FIG. 2.

The error detection component 118 detects errors in the receive one or more data streams, for example based at least in part on the analysis performed by the DPCA modeling component 116. In some embodiments, the error detection component 118 receives a threshold from a user, for example as entered into user interface component 120, that defines a threshold at which a fault would likely be occurring (or at which operation is at least undesirable).

The user interface definition component 120 presents to a user a configurable arrangement with which the scalable data framework can be configured to receive input streams and arrange analyses of those input streams, thereby allowing a user to define various analyses to be performed on the input data streams. This can include, for example, a configurable analysis of multiple data streams based on DPCA modeling and fault detection, as well as data reconstruction, as further discussed below. In conjunction with the user interface definition component 120, the data reconstruction component 122 can be used to reconstruct faulty data according to a selected type of operation. Example operations can include forward data reconstruction 124 and backward data reconstruction 126, as are further discussed below.

The computing system 102 can also include a communication interface 130 configured to receive data streams from the oil production facility 104, and transmit notifications as generated by the data processing framework 114, as well as a display 132 for presenting a user interface associated with the data processing framework 114. In various embodiments, the computing system 102 can include additional components, such as peripheral I/O devices, for example to allow a user to interact with the user interfaces generated by the data processing framework 114.

Referring now to FIG. 2, an example process 200 is illustrated for reconstructing data for a data set is illustrated. The data set used in process 200 can be, for example, a collection of data streams from a data source, such as from the oil production facility 104 of FIG. 1.

In the embodiment shown, the process 200 generally includes monitoring performance of a particular set of dynamic data that can be included in one or more data streams (step 202). Those data streams can be monitored for performance, for example based on a principal component model. The model, for purposes of illustration, can represent a series of N samples for each of a vector of m sensors. Accordingly, a data matrix of samples can be depicted as:

XεR^{N×m}

In this arrangement, each row represents a sample x^{T}.

The matrix X is scaled to a zero-mean, and unit variance, for use in principal component analysis (PCA) modeling. The matrix X is then decomposed into a score matrix T and a loading matrix P by singular value decomposition (SVD), as follows:

X=TP^{T}+\tilde{X}

In this notation, T=XP contains l leading left singular vectors and the singular values, P contains l leading right singular vectors, and \tilde{X} is the residual matrix. As such, the columns of T are orthogonal and the columns of P are orthonormal. The sample covariance can therefore be depicted as:

$$S = \frac{1}{N - 1} {X}^{T} X$$

In the alternative, an eigen-decomposition can be performed on S to obtain P as the l leading eigenvectors of S and all eigenvalues are denoted as:

Λ=diag{λ₁,λ₂, . . . ,λₘ}

In this arrangement, the i^{th} eigenvalue can be related to the i^{th} column of the score matrix T as follows:

$${λ}_{i} = \frac{1}{N - 1} {t}_{i}^{T} {t}_{i} \approx var \{ {t}_{i} \}$$

This represents the sample variance of the i^{th} score vector. Additionally, the principal component subspace (PCS) is Sₚ=span{P} and the residual subspace (RS) Sᵣ is the orthogonal complement. The partition of the measurement space into PCS and RS is performed such that the residual space contains only tiny singular values corresponding to a subspace with little variability, i.e., is primarily noise.

In performing principal component analysis as discussed in further detail herein, a sample vector xεR^{m} can be projected on the PCS and RS, respectively, as \hat{x}ₖ=Ptₖ, where tₖ=P^{T}xₖ is a vector of the scores of l latent variables, with the residual vector being \tilde{x}ₖ=xₖ−\hat{x}ₖ=(I−PP^{T})xₖ.

In conjunction with the present disclosure, it is noted that a dynamic principal component analysis can be employed similarly to the arrangement discussed above, but with the measurements used to represent dynamic data from processes such as oil wells, or oil production facilities. In such cases, the measurement vector can be related to a score vector of fewer latent variables through a transfer function matrix. In this case, the measured variables are not characterized as input and output variables, but rather are related to a number of latent variables to represent their respective correlations. Assuming that zₖ is a collection of all variables of interest at time k, an extended variable vector can be defined as follows:

xₖ^{T}=[zₖ^{T},zₖ₋₁^{T} . . . z_{k-d}^{T}]

The principal component analysis scores can then be calculated as above, as follows:

tₖ=P^{T}[zₖ^{T},zₖ₋₁^{T} . . . z_{k-d}^{T}]^{T}

As a transfer function, this can be represented as tₖ=A(q⁻¹)zₖ. In this representation, A(q⁻¹) is a matrix polynomial formed by the corresponding blocks in P. The latent variables are linear combinations of past data with largest variances in descending order, analogous to a Kalman filter vector.

It is noted that monitored data can, in multivariate process monitoring generally include fault detection (step 204). Typically, squared prediction error (SPE) and/or the Hotelling's T² indices are used to control normal variability in RS and PCS, respectively. With respect to squared prediction error, an index can be used to measure the projection of a particular sample vector on the residual subspace, noted as SPE≡∥\tilde{x}ₖ∥²=∥(I−PP^{T})xₖ∥². In this illustration of SPE, \tilde{x}ₖ=(I−PP^{T})xₖ, and the process is considered normal if SPE is less than a confidence limit δ². When a fault occurs, the faulty sample vector includes a normal portion superimposed with the fault portion, with the fault making SPE larger than the confidence limit (and hence leading to detection of the fault).

Hotelling's T² index measures variations in PCS, namely T²=x^{T}PΛ⁻¹P^{T}x. When normal data follows a normal distribution, the T² statistic is related to an F-distribution, such that for a given confidence level β, the T² statistic can be considered as:

$${T}^{2} \leq {T}_{β}^{2} ≡ \frac{l ( N - 1 )}{N - l} {F}_{l , N - l , β}$$

If there is a sufficiently large number of data points N, the T² index can be approximated under normal conditions with a distribution with 1 degrees of freedom, or T²≦χₗ².

In the context of the present disclosure, a detectable fault will have an impact on the measurement variable that will cause it to deviate from a normal case. While the source of the fault may not be known, its impact on the measurement may be isolable from other faults. As noted herein the measurement vector of the fault free portion can be denoted as z*ₖ which is unknown when a fault has occurred. However, the sampled vector zₖ, corresponding to the received sample measurement, is illustrates as zₖ=z*ₖ+ξᵢfₖ. In this arrangement, ∥fₖ∥ corresponds to a magnitude of the fault, and can change over time depending on the development of the fault over time. The fault direction matrix ξᵢ can be derived from modeling the fault case as deviation from normal operation, or can alternatively be extracted from historical faulty data.

Once a fault is detected, the faulty data can be reconstructed using a variety of techniques, including, as discussed further herein, forward and/or backward data reconstruction based on the squared prediction error (step 206). This can be performed, for example, using the forward or backward data reconstruction operations 124, 126, respectively, of FIG. 1.

In particular, a reconstructed sample vector can be expressed as the actual sample minus the erroneous component, or zₖ^{r}=zₖ+ξᵢfₖ^{r}, with fₖ^{r} representing an estimate of the actual fault magnitude. Correspondingly, the fault free portion of the signal corresponds to zₖ^{a}=(ξᵢ^{perp})zₖ=(ξᵢ^{perp})^{T}z*ₖ, and the fault portion of the vector corresponds to zₖ^{f}=ξᵢ^{T}zₖ.

In an example of the above arrangement, assuming there is an array of 5 sensors, with sensors 2 and 4 having missing values, ξᵢ includes columns of an identity matrix, namely:

$${ξ}_{i} = [ \begin{matrix}0 & 0 \\ 1 & 0 \\ 0 & 0 \\ 0 & 1 \\ 0 & 0\end{matrix} ] ;$$

$${ξ}_{i}^{perp} = [ \begin{matrix}1 & 0 & 0 \\ 0 & 0 & 0 \\ 0 & 1 & 0 \\ 0 & 0 & 0 \\ 0 & 0 & 1\end{matrix} ]$$

Accordingly, the fault vector is represented as zₖ^{f}=[z_{2,k},z_{4,k}]^{T}, and the non-fault vector is represented as zₖ^{a}=[z_{1,k},z_{3,k}z_{5,k}]^{T}; reconstruction is therefore generating zₖ^{f} from zₖ^{a}.

To reconstruct faulty data from non-faulty data (i.e., reconstructing zₖ^{f} from zₖ^{a}), a fault τᵢ at time k₀ and a number of subsequent time intervals, a dynamic PCA process is performed using fault direction ξᵢ such that the effect of the fault is eliminated. In particular, in some embodiments, a forward data reconstruction technique can be used.

To perform the forward data reconstruction technique, it is assumed that a first entry zₖ₀ in xₖ₀ includes a fault in the direction ξᵢ. Accordingly, an optimal reconstruction from complete data up to time k₀−1 and partial data at k₀ is made.

Assuming a start variable j that is initialized at 0, j can be incremented, and at time k₀+j, an optimal reconstruction of zₖ₀₊ⱼ^{r} from complete or previously reconstructed data up to k₀+j−1 and partial data at k₀+j. This process is repeated, including incrementing j, until all faulty samples are reconstructed.

As applied to the vector xₖ, the fault model can be represented as xₖ=x*ₖ+Ξᵢfₖ, where Ξᵢ=|ξᵢ^{T}0 . . . 0|^{T}. Based on this, it is only the first entry zₖ of xₖ that contains a fault and requires reconstruction, using reconstructed sample vector xₖ^{r}, as follows:

xₖ^{r}=xₖ−Ξᵢfₖ^{r}

To perform reconstruction, fₖ^{r} is found, such that the reconstructed squared prediction error (SPE(xₖ^{r})=∥\tilde{x}ₖ^{r}∥²=∥\tilde{x}ₖfₖ^{r}∥²) is minimized, where \tilde{Ξ}ᵢ=(I−PP^{T})Ξᵢ. This can be performed, for example, based on a least squares estimate of the fault magnitude as follows:

fₖ^{r}=\tilde{Ξ}ᵢ⁺\tilde{x}ₖ=\tilde{Ξ}ᵢ⁺xₖ

This leads to a reconstructed measurement vector:

xₖ^{r}=xₖ−ΞᵢΞᵢ⁺xₖ=(I−ΞᵢΞᵢ⁺)xₖ

Residual data space is illustrated as: \tilde{x}ₖ^{r}=(I−\tilde{Ξ}ᵢ\tilde{Ξ}ᵢ⁺)\tilde{x}ₖ. Accordingly, the reconstructed squared prediction error corresponds to ∥\tilde{x}ₖ^{r}∥²=∥\tilde{x}*ₖ∥², which results in entire removal of the fault following reconstruction. For the missing entries in zₖ, these entries are replaced with zeroes; accordingly, the reconstructed missing entries are calculated from:

zₖ^{f,r}=ξᵢ^{T}zₖ^{r}=zₖ^{f}−Ξᵢ⁺xₖ=−Ξᵢ⁺xₖ

The above squared prediction error eliminates the effect of the error in residual space, while leaving principal component variations unchanged. Accordingly, in some embodiments, the magnitude of the T² index is penalized while minimizing the SPE, leading to a global index based reconstruction:

Φ(xₖ^{r})=SPE(xₖ^{r})+μT²(xₖ^{r})=(xₖ^{r})^{T}Φxₖ^{r}

In the above, Φ=I−PP^{T}+μPΛ⁻¹P^{T}. Furthermore, the least-squares reproduction of this, based on the global index, is provided by:

fₖ^{r}=(Ξᵢ^{T}ΦΞᵢ)⁻¹Ξᵢ^{T}Φxₖ

The forward data reconstruction based on the global index follows the same procedure as discussed above, based on SPE.

It is noted that, in eliminating the fault along the fault direction, normal variations along the fault direction are also eliminated. If normal variations are very large in the PCS, in some embodiments the T² index may be excluded.

In the case of forward data reconstruction, it is generally required that the initial portion of the data sequence are normal for at least d consecutive time intervals so that only zₖ in xₖ is missing or faulty. If this is not the case, one can reconstruct the missing or faulty data backward in time.

In the case of backward data reconstruction, the sequence of data that can contain faults, zₖ, can have faults ξᵢ with a direction occurring at time k₀ and a number of previous time intervals. The DPCA model can in this case again be used along the fault direction ξᵢ such that the effect of the fault is eliminated. This backward data reconstruction reconstructs zₖ₀₋ⱼ^{r} (a time from which a fault occurs, backwards in time) based on actual data from z_{k0-j+d}^{r} to zₖ₀₋ⱼ₊₁^{r}, and any available data at zₖ₀₋ⱼ^{r}. In particular, backward data reconstruction includes obtaining an optimal reconstruction zₖ₀^{r} from complete data from k₀+1 and partial data at k₀. Index j is incremented, and at time k₀−j, zₖ₀₋ⱼ^{r} is reconstructed from actual or previously reconstructed data at k₀−j+1, and available partial data at k₀−j. This process is repeated until all faulty samples are reconstructed.

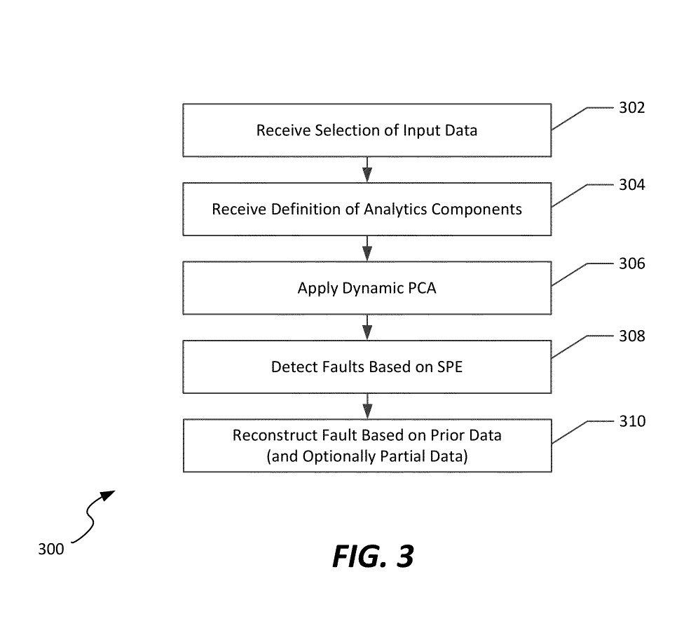

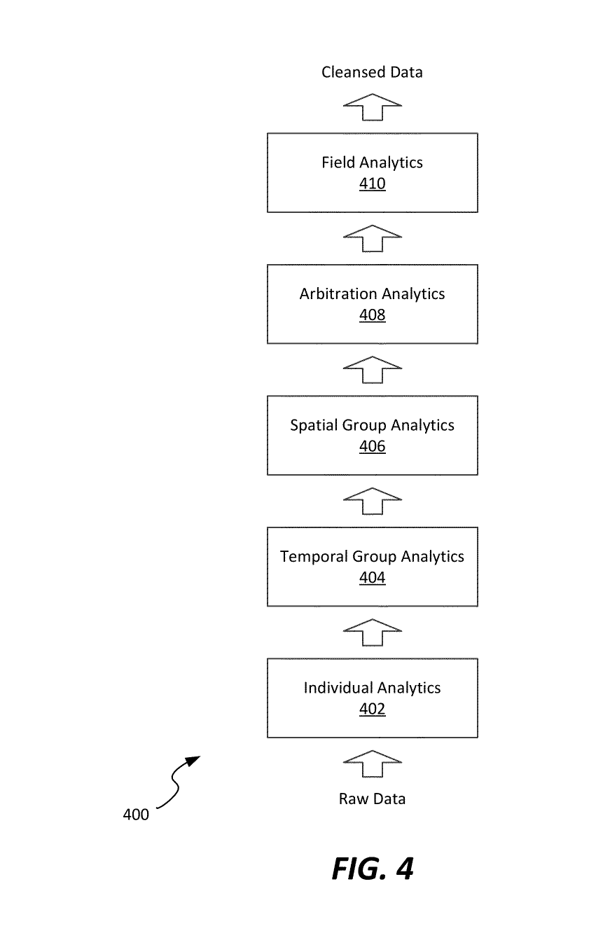

Based on the above, FIG. 3 illustrates a particular embodiment of a method 300 of the present disclosure in which dynamic data can be reconstructed. The method 300 represents a particular application of data reconstruction that is implemented within a scalable data processing framework as discussed herein. In particular, the method 300 can use the modules and user interfaces illustrated in FIGS. 4-11, below, for configurably providing error detection and associated dynamic data reconstruction.

In the embodiment shown, the method 300 includes receiving a selection of one or more input data streams at a data processing framework (step 302). This can include, for example, receiving a definition, from a user at a user interface, of one or more input data streams from an oil production facility. The method 300 can also include receiving a definition of one or more analytics components at the data processing framework (step 304). This definition can include selection of one or more analytics components, and definition of analytics component features to be used, as selected from a pipelined analysis arrangement (e.g., as illustrated in FIG. 4, below). It can also include, for example, receiving one or more configuration parameters from a user that assist in defining the operations to be performed. For example, this can include receiving thresholds from a user that define fault thresholds or other thresholds at which data reconstruction will occur (or a type of data reconstruction to apply).

The method 300 generally includes applying a principal component analysis to the one or more input data streams that were selected in step 302, and in particular, applying a dynamic principal component analysis (step 306). In such embodiments, measured variables (e.g., measurements included in the defined input data streams) are not characterized as input and output variables, but rather are related to a number of latent variables that represent their respective correlations, and are correlated to a window of previous observations of the same features. The method 300 also includes detecting a fault in the one or more input data streams (step 308). This fault detection can be, for example, based on a comparison between a predetermined threshold and a squared prediction error. It can also be based on a variation in principal component subspace generated based on the dynamic principal component analysis. The method 300 can additionally involve reconstructing the fault that occurs in the data of the data streams (step 310). This can include reconstructing the fault based on data collected prior to occurrence of the fault and optionally partial data at the time of the fault, such as may be the case in forward data reconstruction as discussed above. In alternative embodiments, a backward data reconstruction could be used. Furthermore, in some embodiments, the fault can be removed from the measured value, leaving a corrected or “reconstructed” measurement.

Referring now to FIGS. 4-11, various architectural features of a scalable data processing framework are discussed in which the above DPCA and data reconstruction techniques can be employed. In an example embodiment, a scalable data processing architecture 400 can include a plurality of data cleansing modules, of which one or more could include data reconstruction features. In an example embodiment, an Individual Analytics (IA) module 402, Temporal Group Analytics (TGA) module 404, Spatial Group Analytics (SGA) module 406, Arbitration Analytics (AA) module 408, and Field Analytics (FA) module 410, are shown all serialized in a pipeline.

In example embodiments, one or more of the data cleansing modules 402-410 can be arranged to provide the fault detection and reconstruction features discussed above. In an example embodiment, the fault detection and reconstruction features discussed above are included in one or both of the Temporal Group Analytics (TGA) module 404 and the Spatial Group Analytics (SGA) module 406.

It is noted that, in some embodiments of the architecture 400, the order/sequence of applying modules 402-410 is fixed; however, in other embodiments, the modules 402-410 can be executed in parallel. Furthermore, in some embodiments, the combination of modules applied to a particular data stream is configurable. Moreover, the operators applied within each module are also configurable/programmable. The operators can also be implemented in a number of ways; for example, declarative continuous queries, or user-defined functions or aggregates could be used. In comparison, the declarative continuous queries have less functionality, but more flexibility, than the user-defined functions.

In some embodiments, the Individual Analytics (IA) module 402 includes operators that operate on single data values in input data streams. These operators can be used to clean and/or filter individual data items only based on the value of the item itself. Example IA operators can include simple outlier detection (e.g., exceeding thresholds), or raw data conversion (e.g., heat sensors output data into voltages, which must be converted to temperature by considering calibration of that sensor). Other operators could also be included in the IA module 402 as well.

In example embodiments, the Temporal Group Analytics (TGA) module 404 includes operators that operate on data segments in input data streams. These operators can be configured to clean individual data values as part of a temporal group of values by considering their temporal correlation. The TGA operators can be implemented using window-based queries. Example TGA operators include generic temporal outlier detection operators and temporal interpolation for data reconstruction, as is discussed in detail above.

In example embodiments, the Spatial Group Analytics (SGA) module 406 includes operators that operate on data values from multiple data streams. These operators clean individual data values as part of a spatial group of values by considering their spatial correlation, and can be implemented, in some embodiments, using window join queries. One example SGA operator is a generic spatial outlier detection (e.g., within a spatial granule this operator can compute the average of the readings from different sensors and omit individual readings that are outside of two deviations from the mean).

In example embodiments, the Arbitration Analytics (AA) module 408 includes operators that operate on data values from multiple spatial granules to arbitrate the conflicting cleansing decisions. Example AA operators include conflict resolution and de-duplication operators.

In example embodiments, the Field Analytics (FA) module 410 includes operators that operate on data values from multiple stream sources of different modalities (e.g., heat and pressure). These operators can be used to consider correlation between data values of distinct modality and leverage this correlation to enhance data cleansing results. An example FA operator provides outlier detection by cross-correlation of data streams.

The data cleansing modules 402-410 operate on the data in sequence, with disjoint and covering functionality; i.e., they each focus on a specific set of data cleansing problems, and are complementary. In sequence, the modules 402-410 focus on finest data resolution (single readings) to coarsest data resolution (multiple sensors and various modalities). In turn, each module implements one or more data cleansing “operators”, all focusing on the type of functionality supported by the corresponding module.

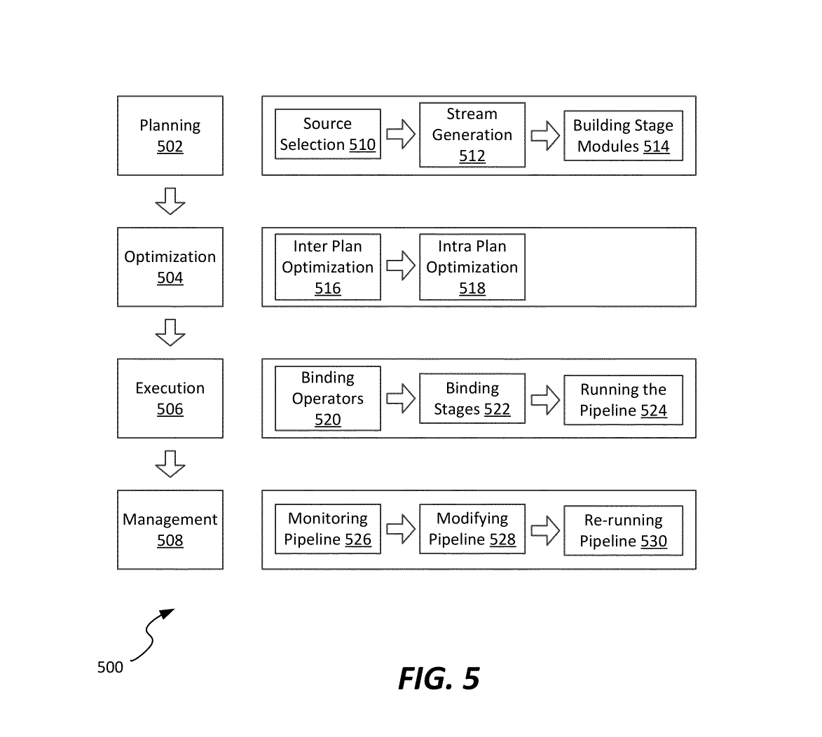

Referring now to FIG. 5, a system 500 implementing the architecture 400 is illustrated, considering specific requirements and capabilities of such a scalable platform. In particular, a management framework and associated stream data processing engine are used to create a data processing framework, such as data processing framework 114 of FIG. 1.

In the embodiment shown, the system 500 includes four stages, including a planning stage 502, an optimization stage 504, an execution stage 506, and a management stage 508. In the planning stage 502, the system includes source selection 510, generation of data streams 512, and building one or more stage modules 514. To accomplish these tasks, the system 500 guides the user to interactively plan a data cleansing task by configuring the operators and modules, resulting in a directed acyclic graph of operators and tuned parameters that defines the flow of the raw data among the operators.

In the optimization stage 504, the graph of operators is reconfigured such that the functionality of the graph stays invariant, while the performance is optimized for scalability. This involves addressing a number of data streams and the rate of the data in each stream, relative to both inter-plan optimization 516 and intra-plan optimization 518, based on the available computing resources on computing system 102.

In the execution stage 506, the optimized plan is enacted by binding the corresponding operators 520, binding the associated stages 522, and executing the plan 524 using the pipelined modules. Finally, in the management stage 508, the system 500 allows a user to manage the executed tasks, for example to monitor the pipeline modules 526, modify the pipeline as needed 528, and re-run the pipeline 530, for example based on the modifications that are made.

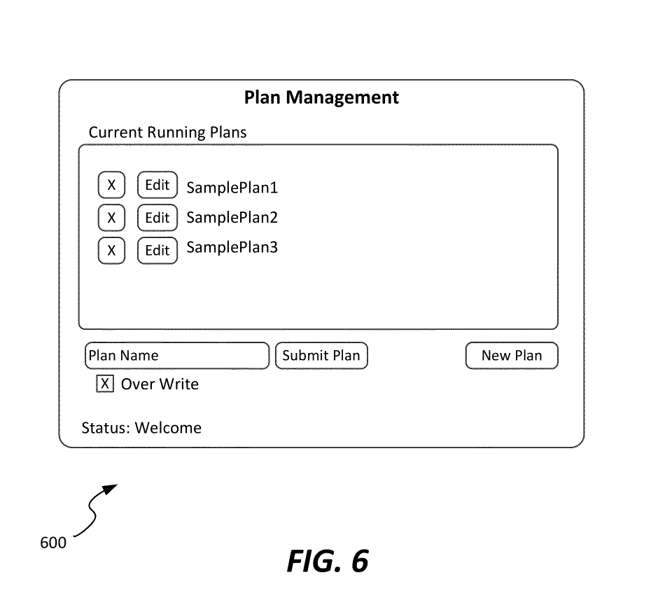

Referring now to FIGS. 6-8, graphical user interfaces that can be generated by the system 500 are shown, and which can be used by a user to manage and define data cleansing operations. For example, in FIG. 6, a graphical user interface 600 is shown that is generated by the system 500, within the framework 400, and which allows a user to manage a modular, scalable data cleansing plan that includes data reconstruction as discussed above. The user interface 600 can be, for example, implemented as a web-based tool generated or hosted by a computing system, such as system 102 of FIG. 1, thereby allowing remote definition of data cleansing plans. In various embodiments, the graphical user interface can be implemented in a variety of ways, such as using PHP, Javascript (client-side), or a variety of other types of technologies. The graphical user interface 600 presents a number of pre-defined data cleansing plans, and allows a user to view, delete, edit, or otherwise select an option to define a new data cleansing plan as well.

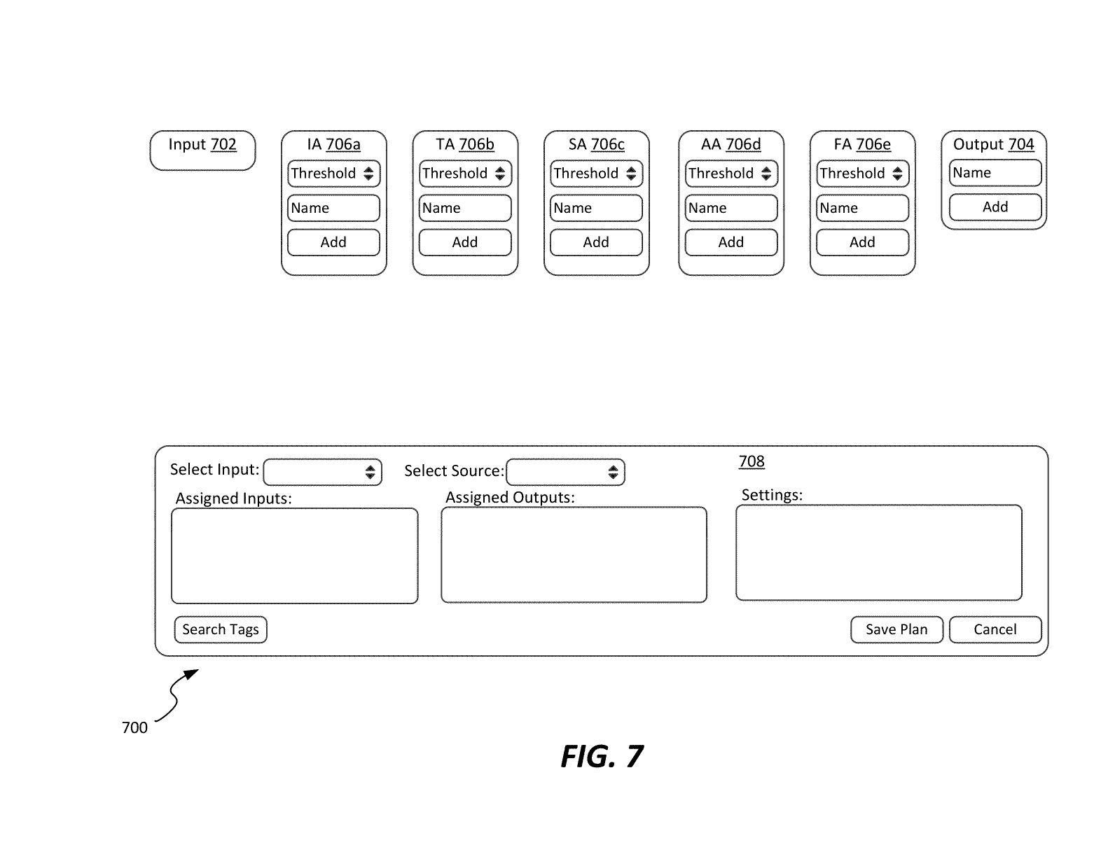

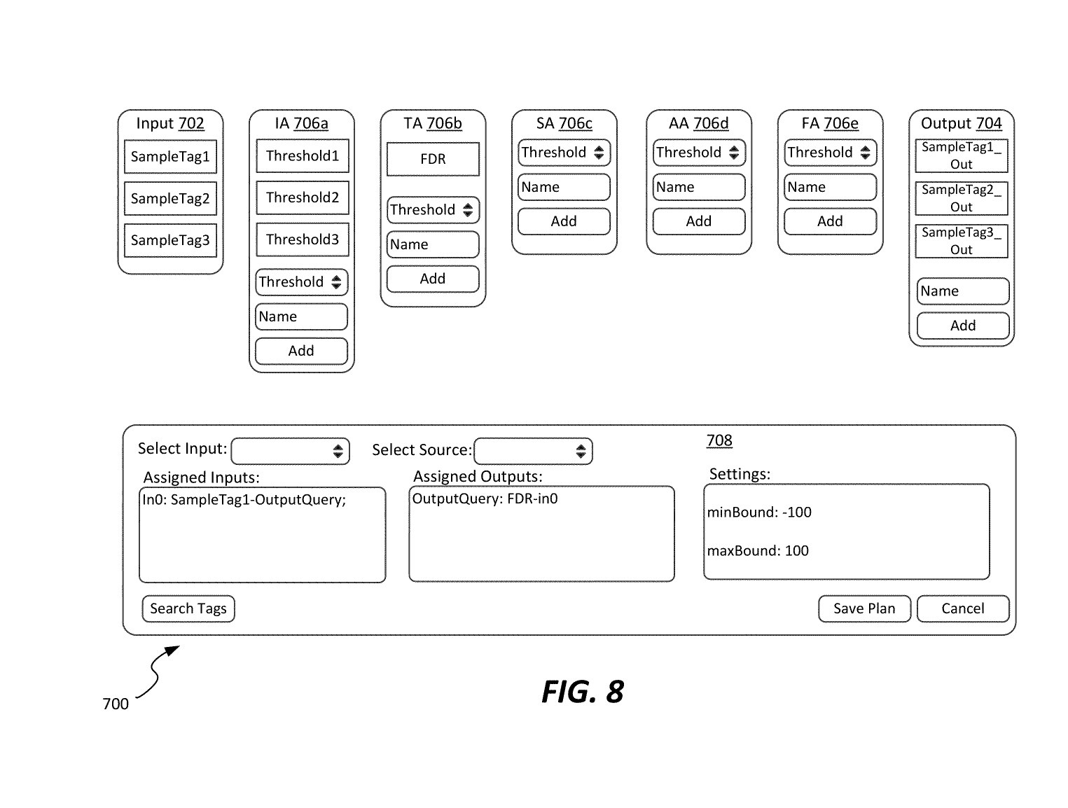

FIGS. 7-8 illustrates a further example user interface 700 of the system 500, which allows the user to define specific operations to be performed as part of a data cleansing plan. In particular, FIG. 7 shows the generalized user interface 700, while FIG. 8 shows the interface with a sample data cleansing plan developed and capable of being edited thereon.

In the user interface 700, an input definition region 702 and output definition region 704 allow a user to define input and output tags for the plan to be developed. A user can select the desired input tags by searching and filtering the tags based on the tag attributes (e.g., location). For each input added to the plan, a corresponding output tag can be automatically added; however, the list of the output tags is editable (tags can be added or deleted by the user on demand).

Once the desired lists of inputs and outputs are specified for the plan, a user can add as many different operators as needed from any of the five modules, illustrated in FIG. 4, using corresponding regions 706a-e. While an operator is being added to the plan, it can also be configured by setting one or more operator-specific parameters using the pane 708 shown at the bottom of the interface. Finally, input and output sets for the operators can be interconnected by simply clicking on the corresponding operators that feed them or are fed by them, respectively. Once a plan is finalized, the user can save the plan and submit the plan for execution by the core engine. In the particular example shown, a plan that includes forward data cleansing in region 706b is illustrated.

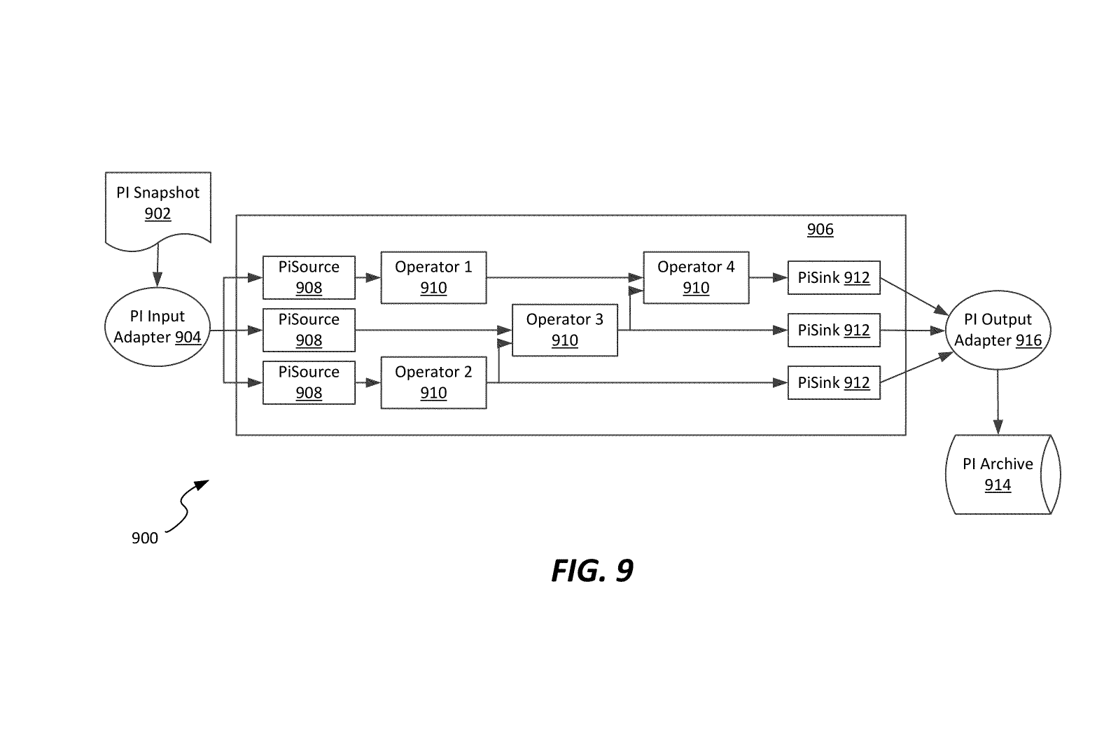

Referring now to FIGS. 9-11, data structures are illustrated for routing input data streams through the data processing components of the framework 400, based on defined operators in a data cleansing plan as defined using the user interfaces of FIGS. 6-8. In the embodiment shown, input data, in the form of a data snapshot 902, is received at an input adapter 904 and fed to a processing engine 906. The input data can be received from a time-series database 916, with data from each of a plurality of data streams managed under a unique tag name. The processing engine applies the defined data cleansing plan to the data, based on one or more sources (defined input tags) 908, operators 910 (as defined in the user interface, and including forward/backward data reconstruction), and sinks (defined output tags 912). The data streams, once processed, are returned to the database 914 via an output adapter 916.

In the example embodiment shown in FIG. 9, each data cleansing plan can use only a single input adapter 904. The input adapter 904 reads the data coming in from multiple streams and groups them into an aggregated data stream and feeds it to the engine 906. The running operators 910 often do not require all the data we are reading from the PI Snapshot. A source module 906 (depicted as “PiSource”) is responsible for extracting the specific data that the operators require from the super-stream.

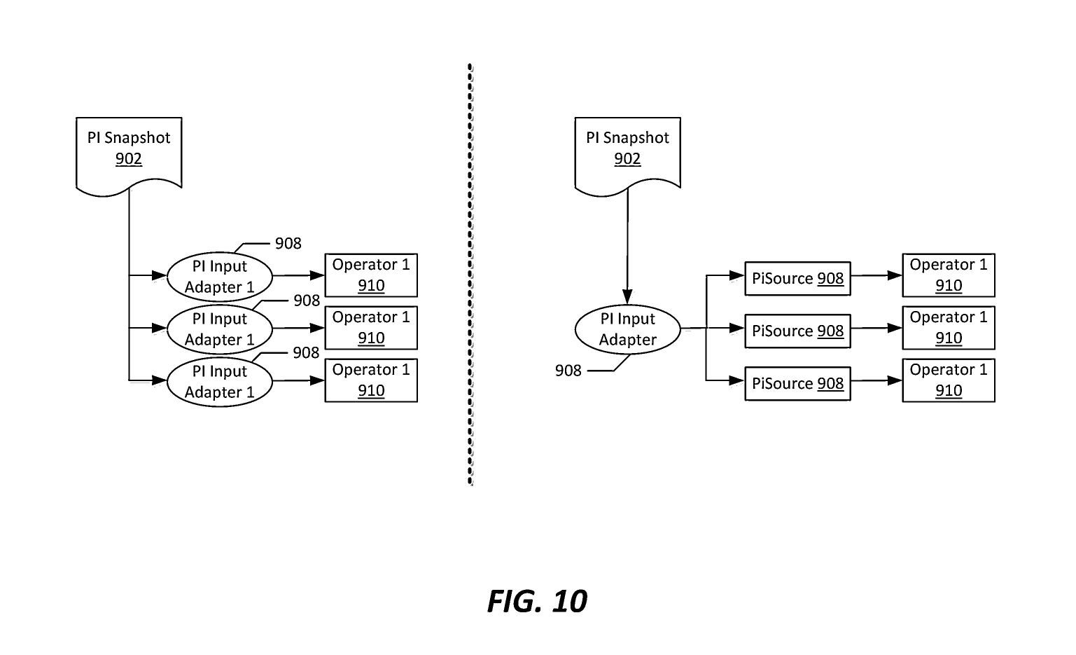

As shown in design alternatives illustrated in FIG. 10, two alternative arrangements are shown, in which either (1) a single adapter is used for multiple data streams and associated operators 910, or multiple adapters 904 are used, with one per specific data stream. However, it is noted that in some embodiments, adapters 904 can demand substantial system resources. By using only one input adapter to read all input data, although filtering the data is required, the use of system resources is optimized. This significantly improves the scalability of the system. A similar design arrangement holds for output adapter design.

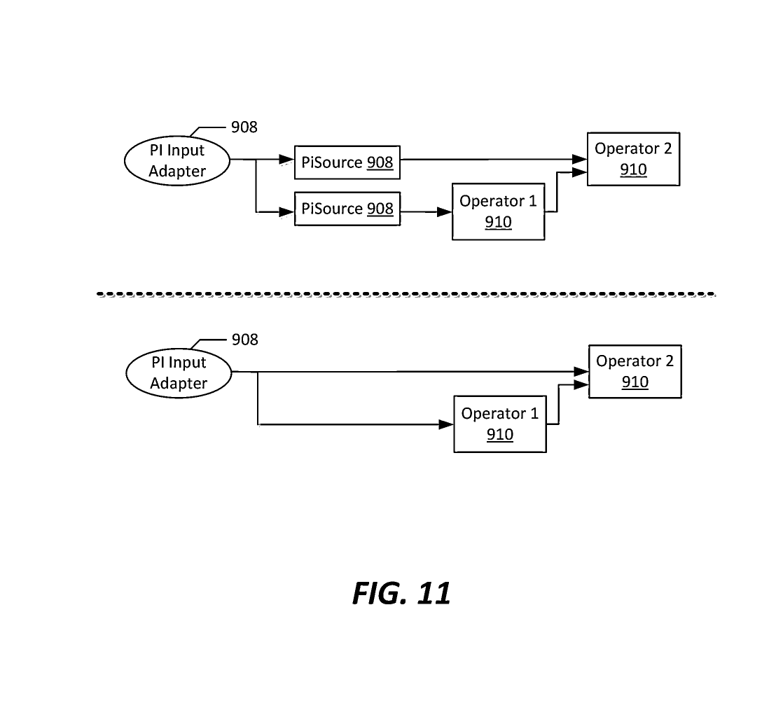

Referring to FIG. 11, it is noted that the sources 908, or input stream interfaces, operate as a universal interface, and can seamlessly read data either from the output of another operator or from the output of another source 908. Accordingly, FIG. 11 illustrates design alternatives with and without the source module 908, which complicates implementation of the operators 910 since the operators receive all types of stream data and must each parse the data individually.

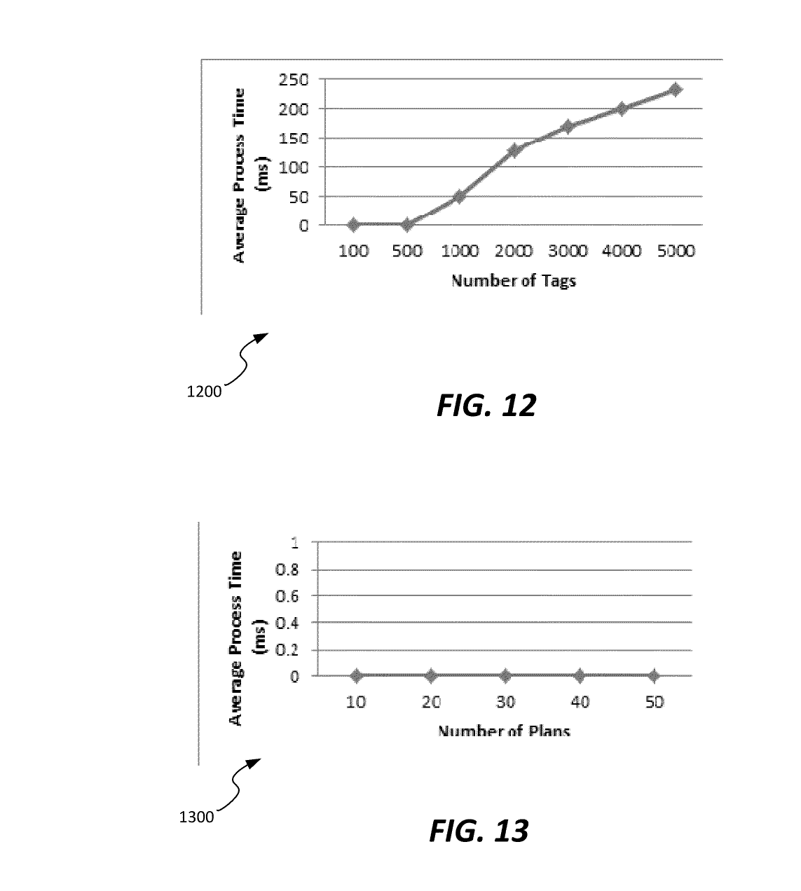

Referring now to FIGS. 12-13, graphs 1200, 1300, respectively, of experiments performed using the systems of FIGS. 4-10 are shown in which scalability of the systems is illustrated. In particular, in the experiments performed, a set of randomly-generated tags and readings were used.

In FIG. 12, the graph 1200 illustrates scalability of the overall framework as related to a number of input tags, which represent input data streams or data sources to be managed by the framework. In particular, processing time of each data item received from a tag was measured by recording an entry time at the snapshot 902 of FIG. 9, and an exit time for storage of data in database 914 of FIG. 9.

In the illustration shown, although the complexity of the algorithms/operators applied to the data items affects the processing time of the data item, throughout this experiment the same data cleansing operators were applied to all data items to isolate the scalability feature as the only standing variable. As seen, when up to 5,000 tags are used, process time remains below 250 ms. Furthermore, with fewer than 500 tags, the process time for data items remains negligible.

In FIG. 13, the graph 1300 shows scalability of the framework as the number of simultaneously running plans grows. In the experiment run to generate graph 1300, a plan with 100 input tags is used, and multiple instances of that same plan are executed, while measuring the processing time for the input data items. As illustrated, the overhead of adding new plans is negligible.

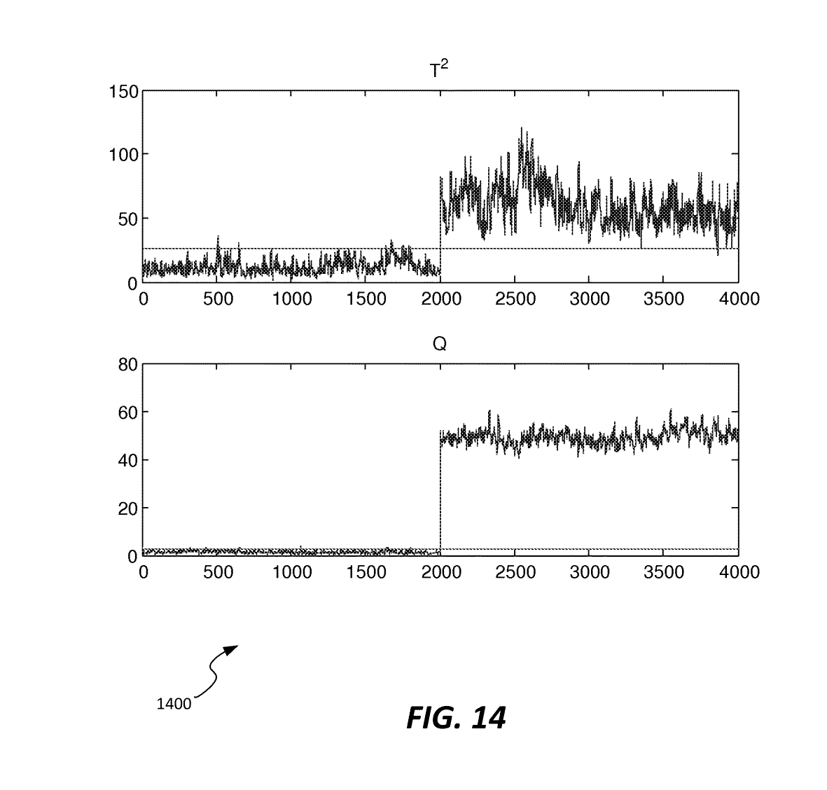

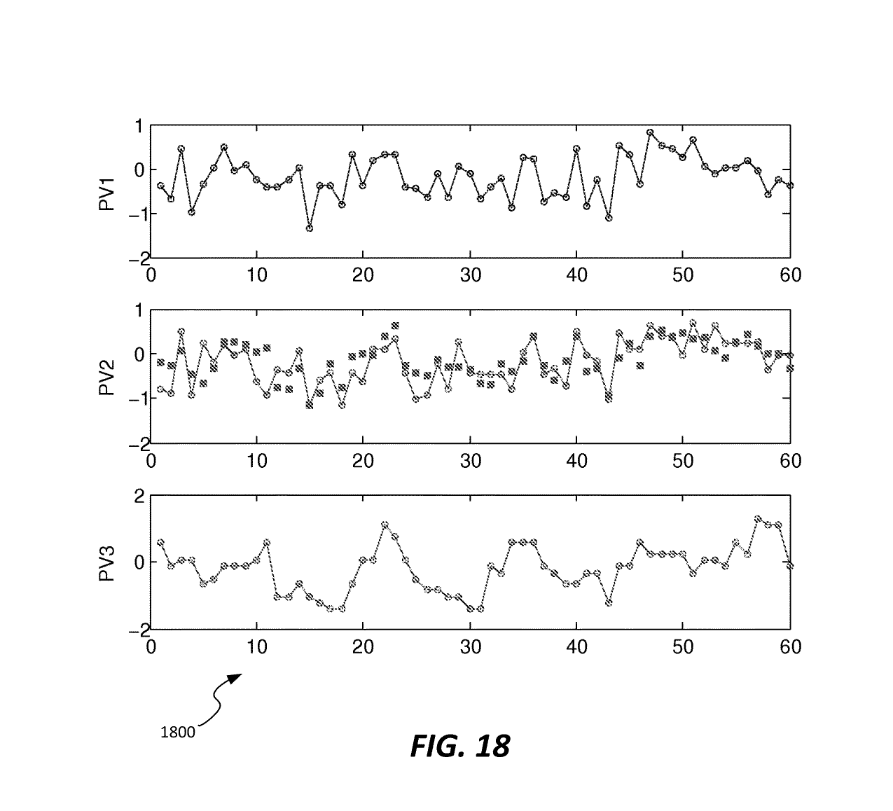

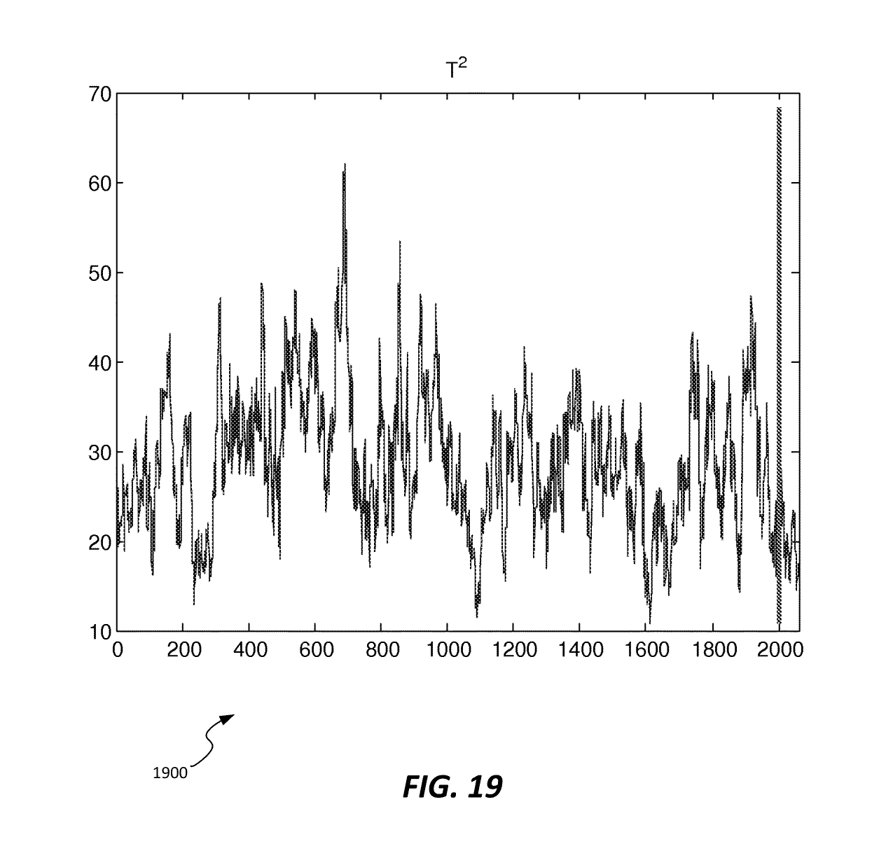

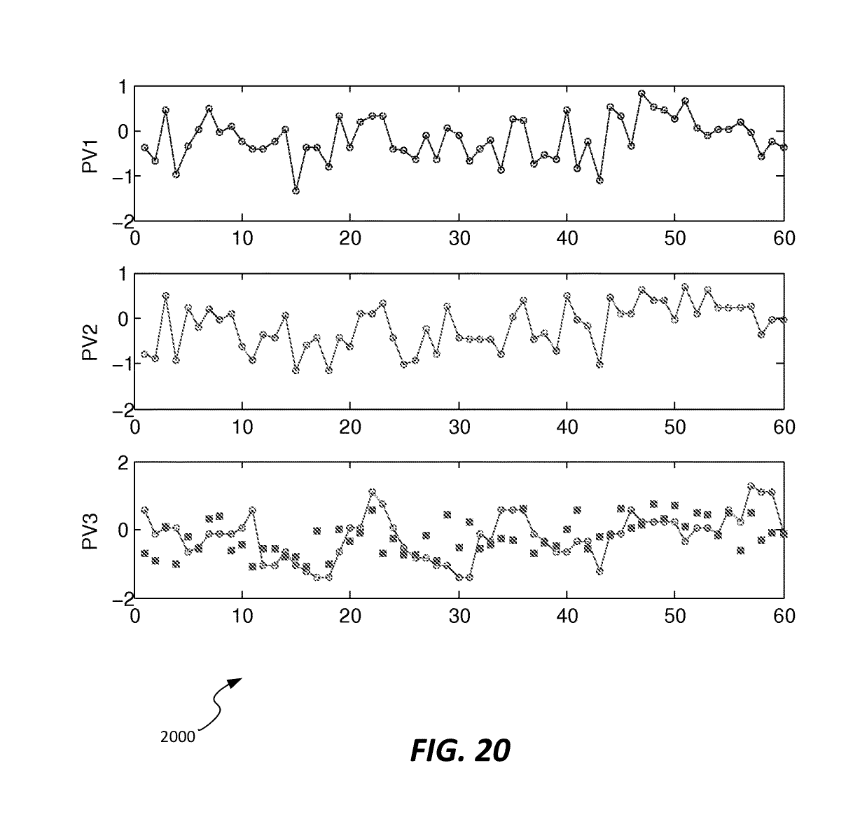

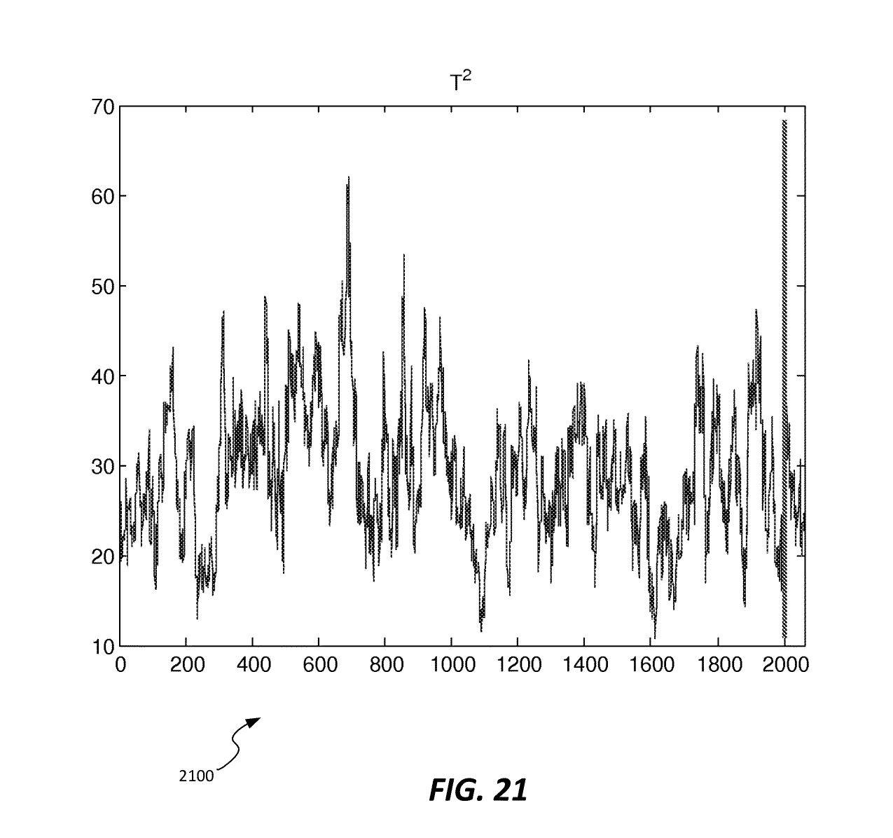

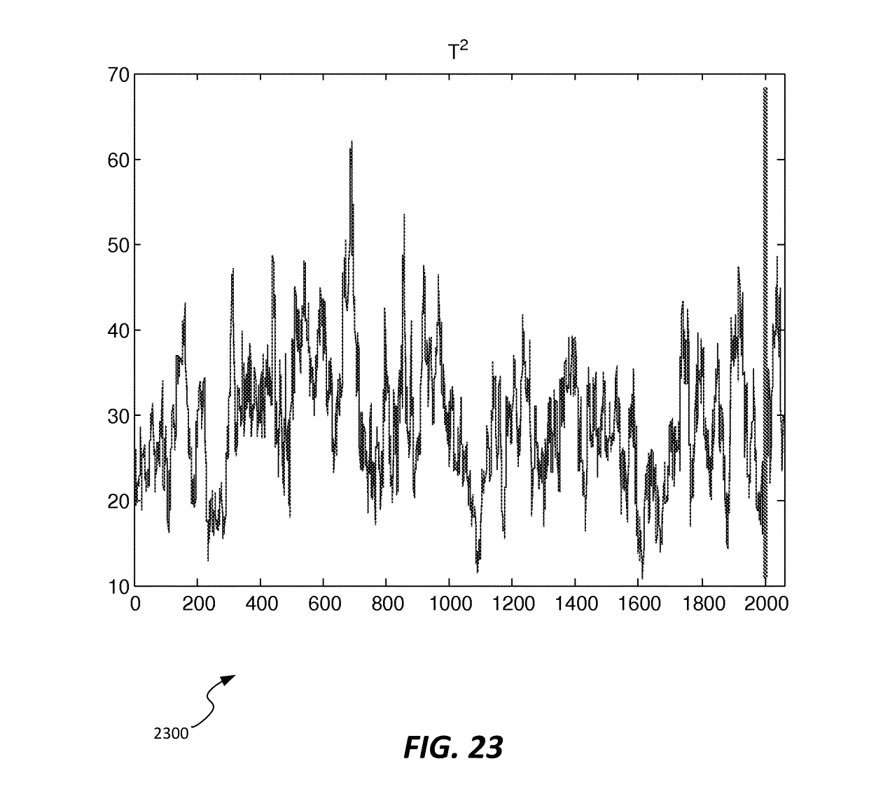

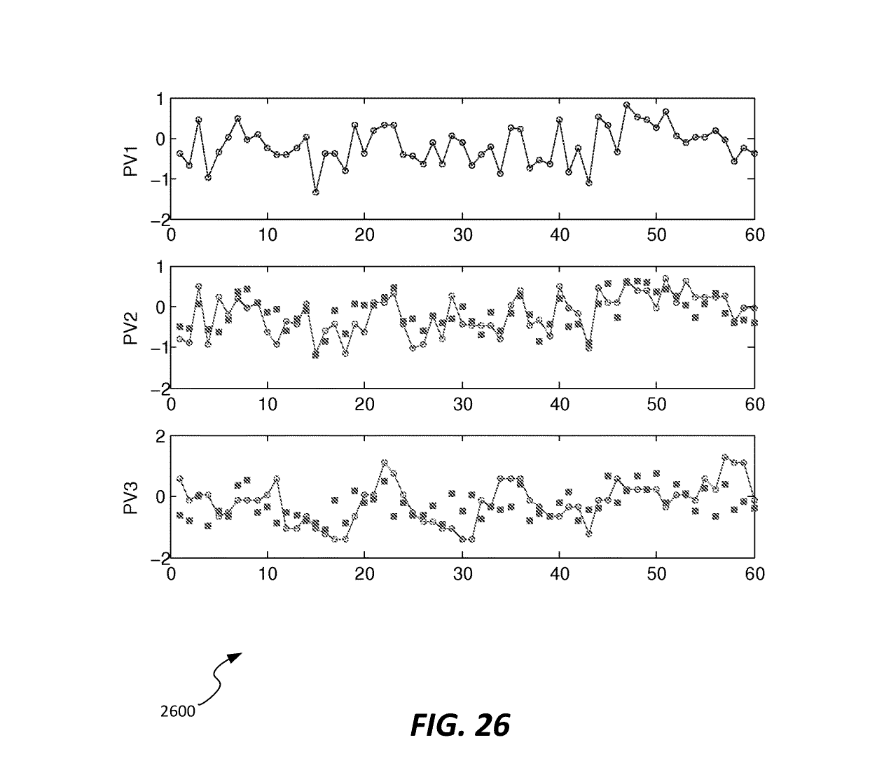

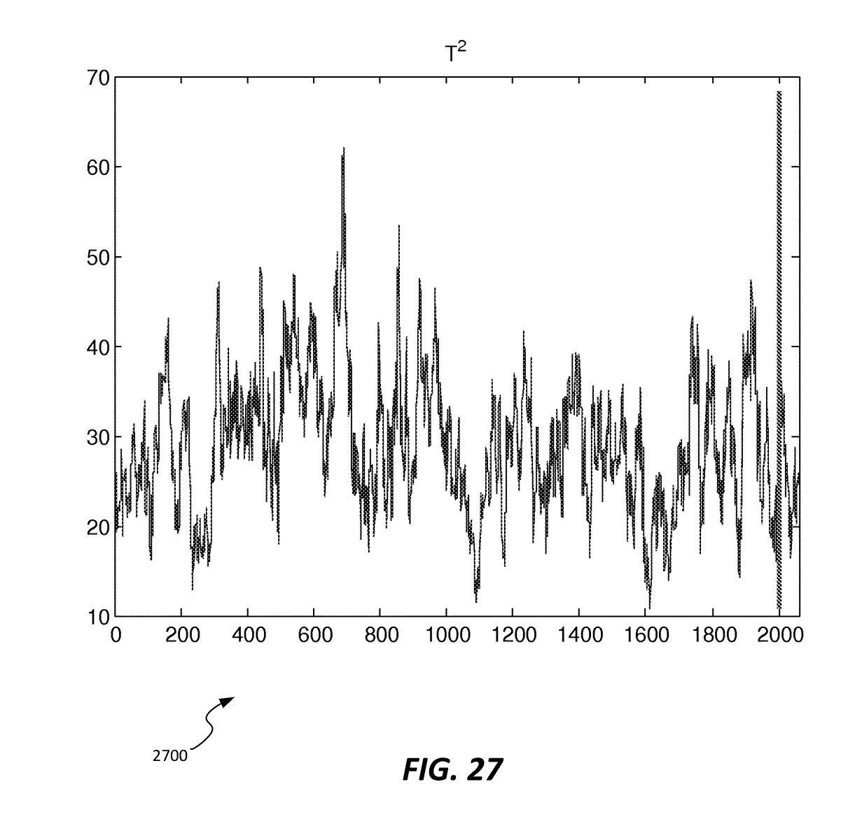

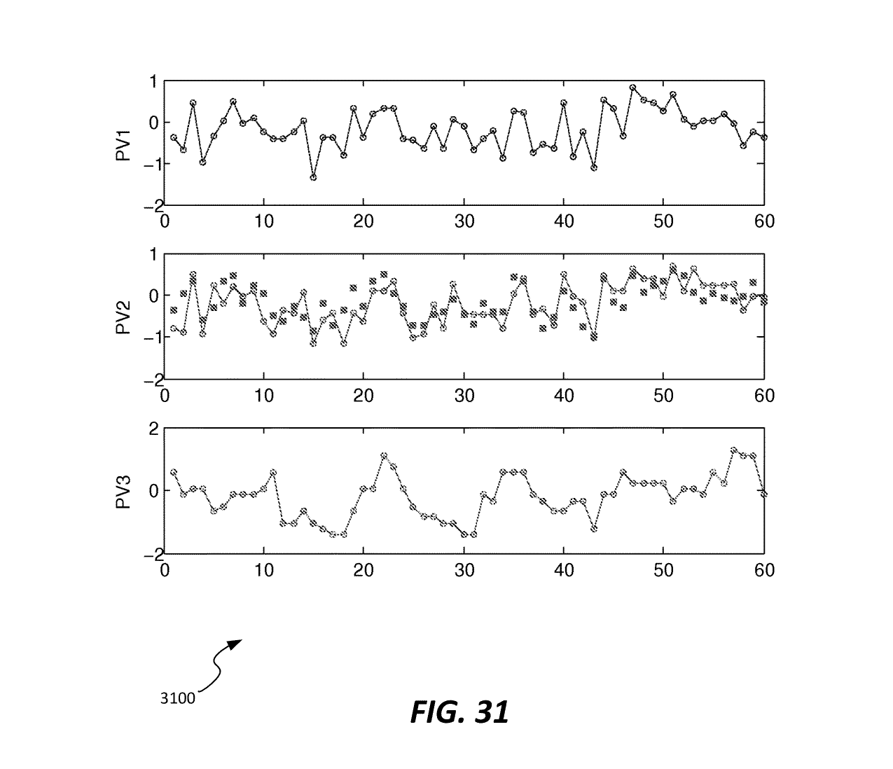

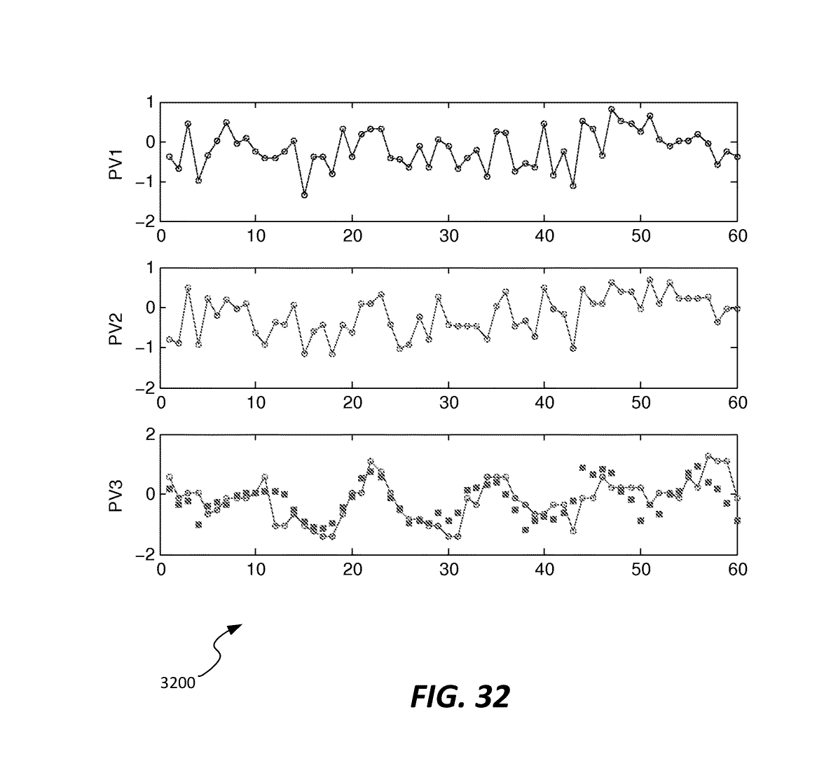

Referring now to FIGS. 14-36, example experimental results are shown for different types of errors that are observed in a system under test within the framework of FIGS. 4-11, and using the methods and systems described above in connection with FIGS. 1-3.

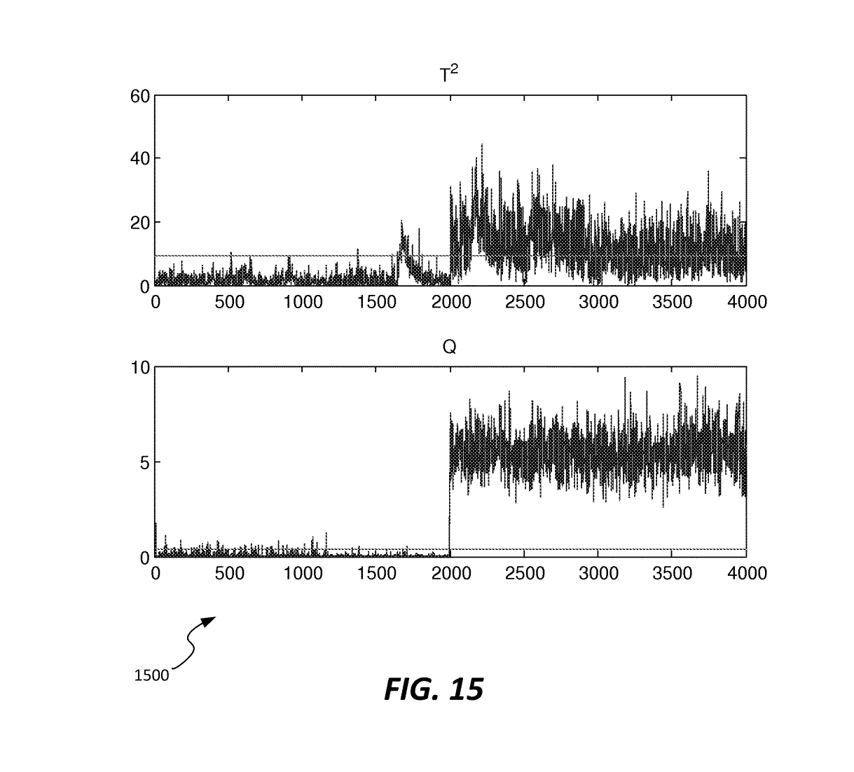

In FIGS. 14-15, example charts 1400, 1500, respectively, are depicted that show different types of principal component analysis of a step fault that occurs in a system, according to example embodiments. In particular, chart 1400 of FIG. 14 shows use of dynamic principal component analysis as discussed above, while chart 1500 of FIG. 15 shows standard principal component analysis. In particular, the dynamic principal component analysis of FIG. 14 has a T² and Q value (representing fault detection rates) of 100% m while standard principal component analysis shows a fault detection rate T² of 59%.

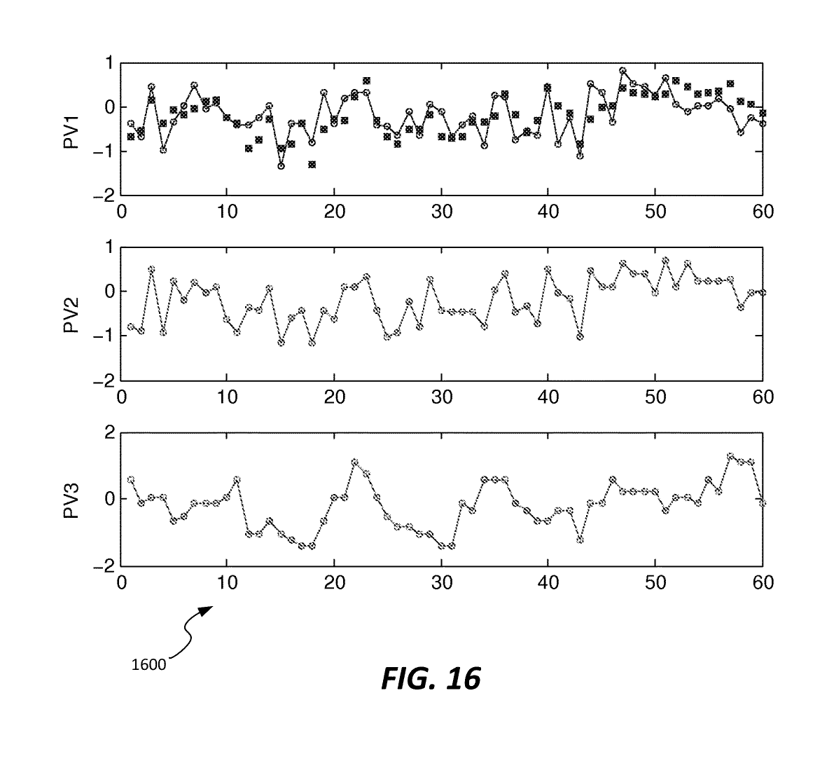

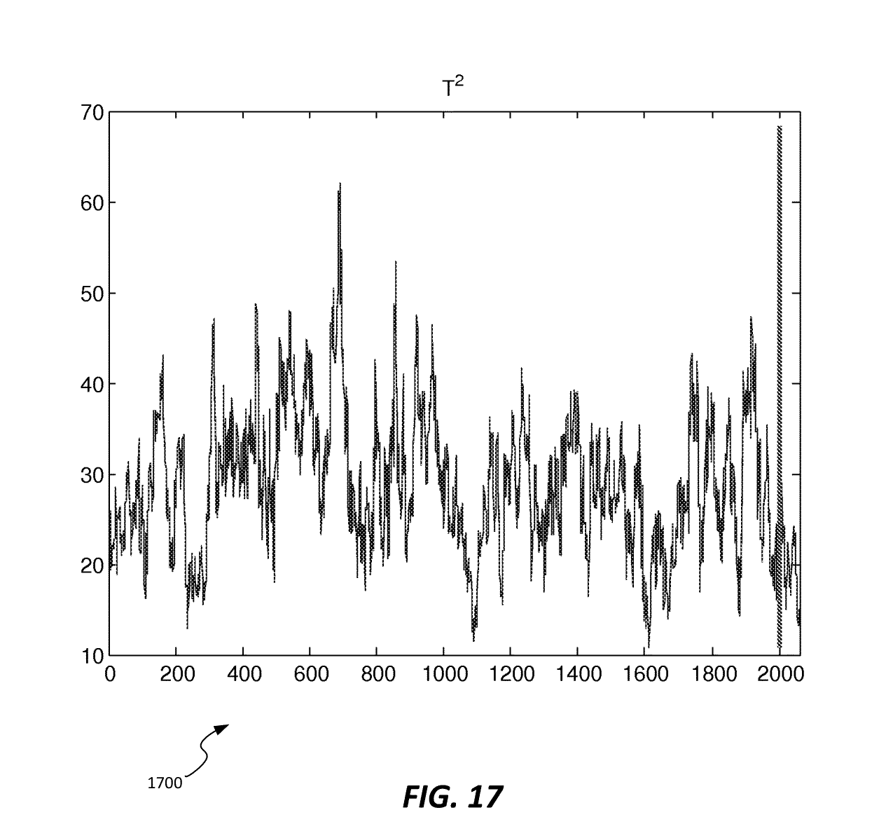

Referring to FIGS. 16-29, example experimental results for forward data reconstruction are shown. In particular, forward data reconstruction based on squared prediction error (SPE) as discussed above is performed.

In running the experiments illustrated in FIGS. 16-29, a training process is performed in which one sensor at a time (of three sensors) is allowed to go missing, and 2000 data points are reconstructed using the forward data reconstruction procedure. The mean squared error of reconstruction is then calculated. This is then repeated for each permutation of missing sensors, and an averaged mean squared error is calculated. The best number of principal components corresponds to the smallest averaged mean squared error.

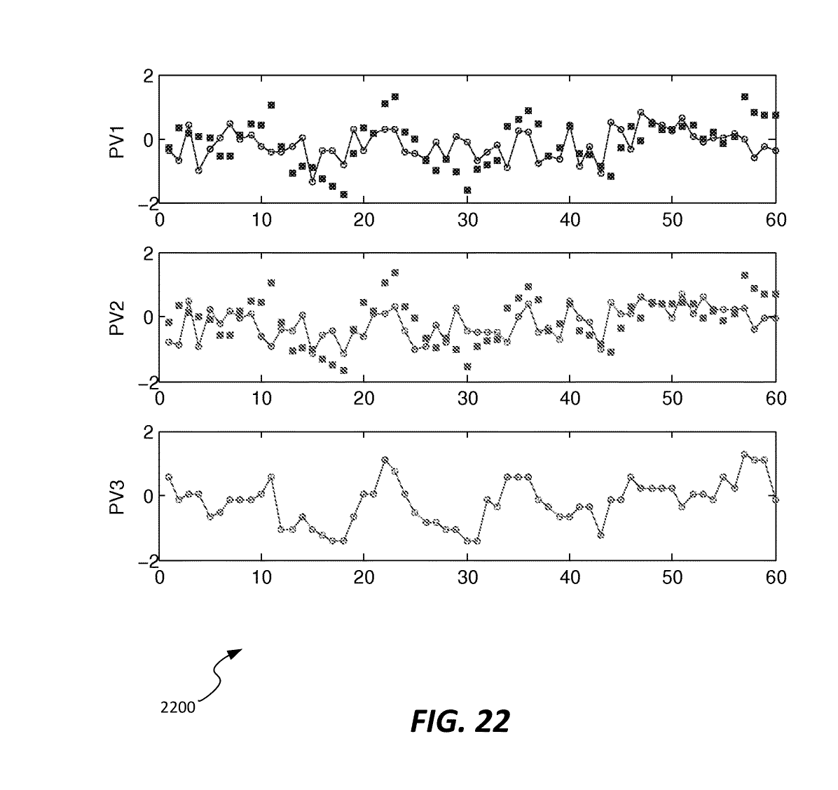

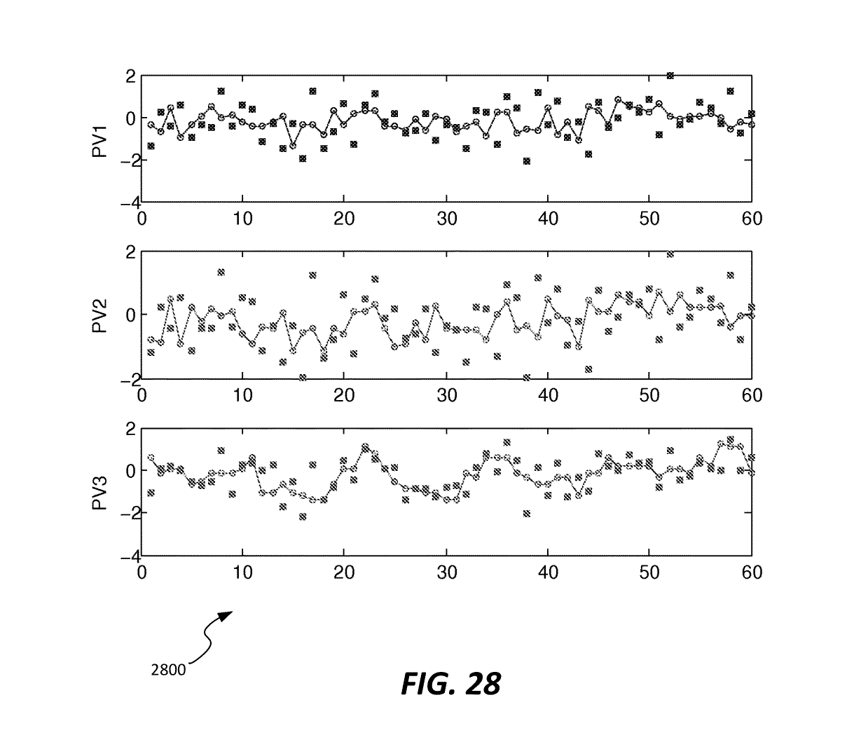

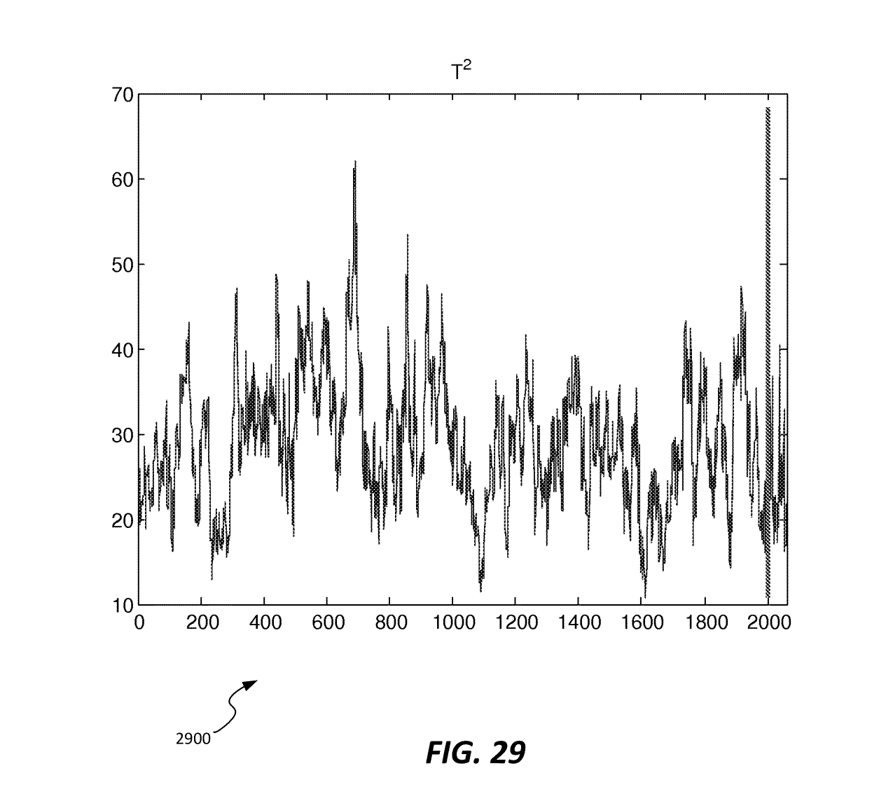

In performing the testing arrangement illustrated in FIGS. 16-29, three fault scenarios are illustrated: a single sensor is missing (FIGS. 16-21), two sensors are missing (FIGS. 22-27), and three sensors are missing (FIGS. 28-29), where one-step-ahead prediction is performed. Additionally, in these scenarios, 60 missing data points are tested, and T² indices are calculated. In particular, for the single sensor and two sensor cases, the T² indices are calculated on:

$$\begin{matrix}{z}_{k}^{r} & {z}_{k - 1} & {z}_{k - 2} & … & {z}_{k - d} \\ {z}_{k + 1}^{r} & {z}_{k}^{r} & {z}_{k - 1} & … & {z}_{k - d + 1} \\ {z}_{k + 2}^{r} & {z}_{k + 1}^{r} & {z}_{k}^{r} & … & {z}_{k - d + 2} \\ ⋮ & ⋮ & ⋮ & ⋮ & ⋮ \\ {z}_{k + n}^{r} & {z}_{k + n - 1}^{r} & {z}_{k + n - 2}^{r} & … & {z}_{k - d + n}^{r}\end{matrix}$$

For the three-sensor case, the T² indices are calculated on:

$$\begin{matrix}{z}_{k}^{r} & {z}_{k - 1} & {z}_{k - 2} & … & {z}_{k - d} \\ {z}_{k + 1}^{r} & {z}_{k} & {z}_{k - 1} & … & {z}_{k - d + 1} \\ {z}_{k + 2}^{r} & {z}_{k + 1} & {z}_{k} & … & {z}_{k - d + 2} \\ ⋮ & ⋮ & ⋮ & ⋮ & ⋮ \\ {z}_{k + n}^{r} & {z}_{k + n - 1} & {z}_{k + n - 2} & … & {z}_{k - d + n}\end{matrix}$$

After a training process, it was determined that the optimal number of principal components for this experiment was 29, with a corresponding averaged mean squared error of 0.2745.

In the experiments shown, the mean squared error for the corresponding experiments, in which individual sensors 1, 2, and 3 were missing, are 0.1465, 0.1477, and 0.4912, respectively. FIGS. 16, 18, and 20 illustrate charts 1600, 1800, and 2000, respectively, in which data reconstruction is illustrated. In each of the charts, the square-shaped data points are reconstructed values, while the open circles correspond to actual values. The corresponding T² indices, in charts 1700, 1900, and 2100 of FIGS. 17, 19, and 21, respectively, show arrangements in which the first 2000 points are training data and the final 60 data points are test data. As illustrated, the range of index values for the test data falls into the range of the T² index for the training data, further validating this methodology.

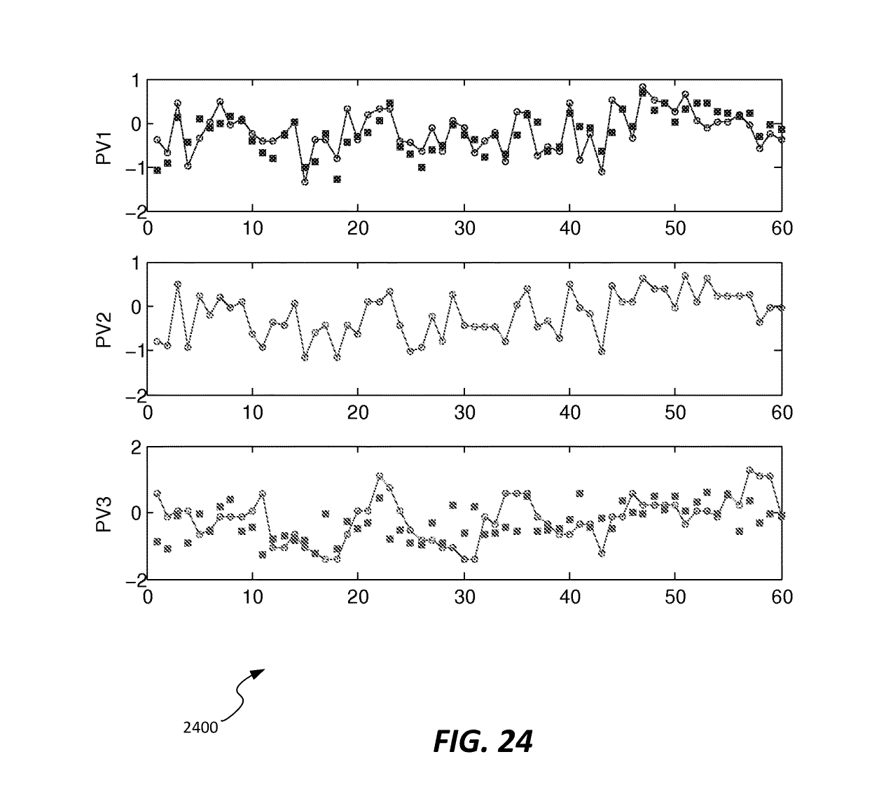

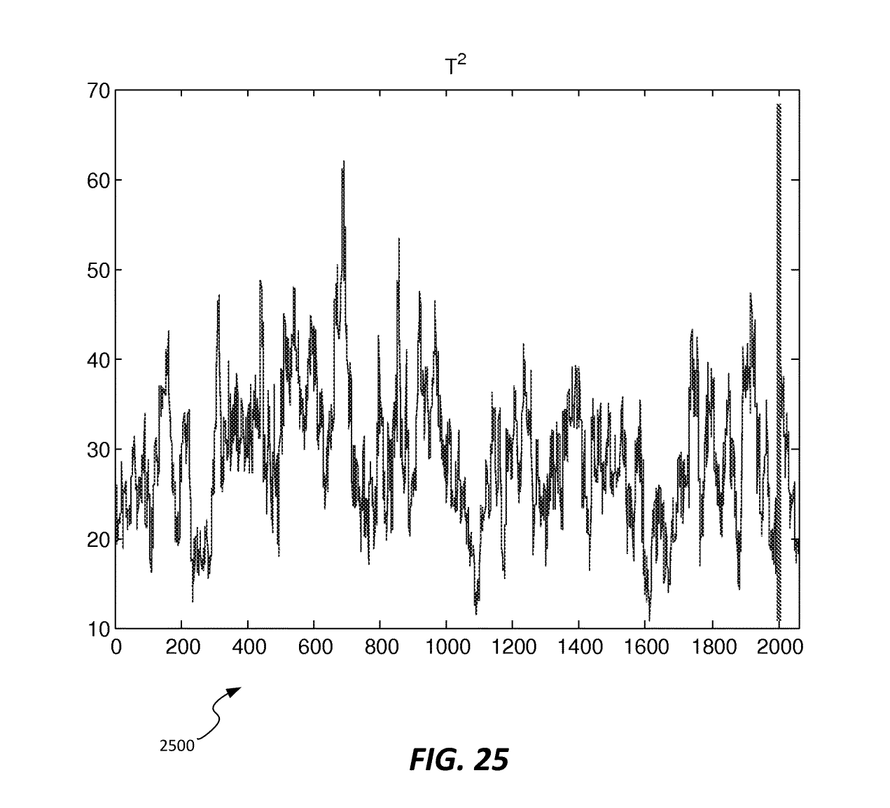

Referring now to FIGS. 22-27, reconstruction results for the two-sensor missing arrangements are illustrated. In these examples, FIGS. 22, 24, and 26 each show charts 2200, 2400, 2600, respectively, illustrating data reconstruction, while FIGS. 24, 25, and 27, respectively show charts 2300, 2500, and 2700 illustrating the T² indices. In these examples, the T² index for the testing data again falls within the range of the training data. Furthermore, the mean squared error for the examples shown are as follows:

Sensors 1, 2 Missing: 1.0998

Sensors 1, 3 Missing: 0.6334

Sensors 2, 3 Missing: 0.5941

FIGS. 28-29 illustrate a chart 2800 of example experimental results and a graph 2900 of T² indices, respectively, for forward data reconstruction in the event that three sensors are missing. In this case, one-step-ahead prediction is performed as noted above. In this example, the mean square error is 2.5423, and again the T² value for the testing data falls within the range of the T² value for training data.

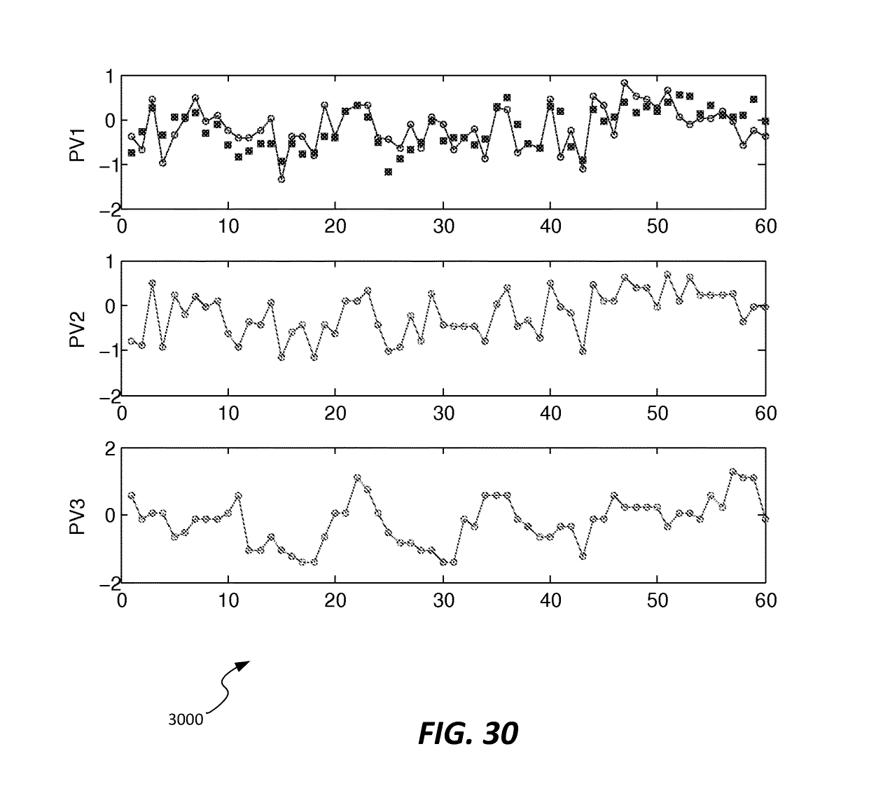

Referring to FIGS. 30-36, example experimental results for backwards data reconstruction are illustrated. The examples of FIGS. 30-36 use the same training and testing data as was used in FIGS. 16-29. Additionally, the appropriate number of principal components is determined by allowing one sensor to be missing at a time, reconstructing 2000 data points using backward data reconstruction and calculating the corresponding mean squared error for each principal component number, and repeating the last step for each case. The average mean squared error for the 3 sensor missing cases is then calculated for each number of principal components, and the best number of principal components is selected based on a smallest averaged mean squared error. Again, three fault scenarios are shown, in which one, two or all three sensors are missing.

In the example embodiments of FIGS. 30-32, charts 3000, 3100, 3200 are respectively shown, illustrating backwards data reconstruction in the event of first, second, and third sensors missing, respectively. In these cases, 60 missing data points are tested, and mean squared error is calculated as follows:

Sensor 1 Missing: 0.1428

Sensor 2 Missing: 0.1351

Sensor 3 Missing: 0.2944

After a training process, a set of 28 principal components was selected, with an average mean squared error of 0.2754.

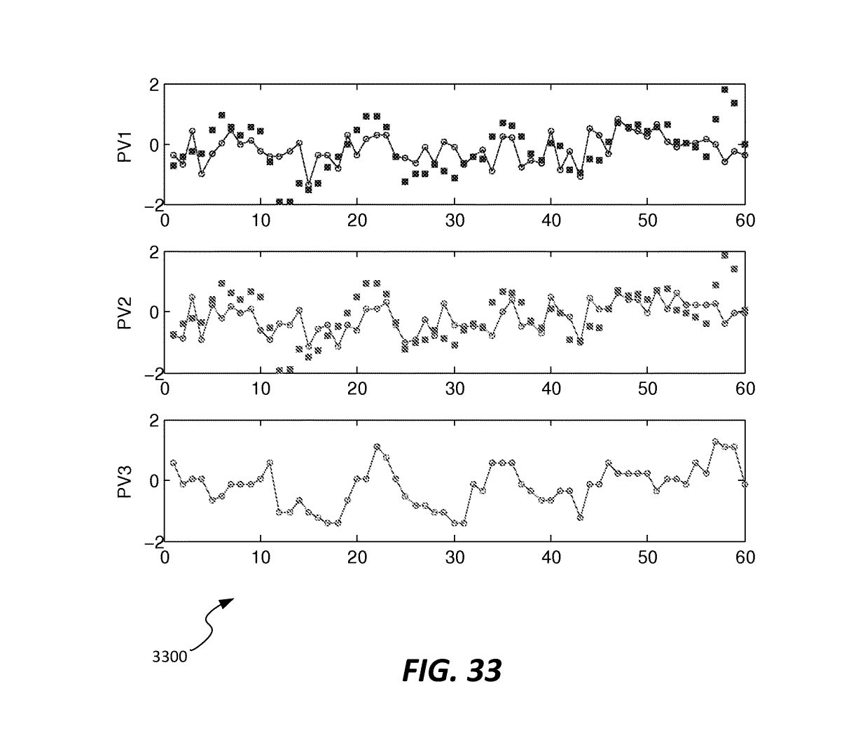

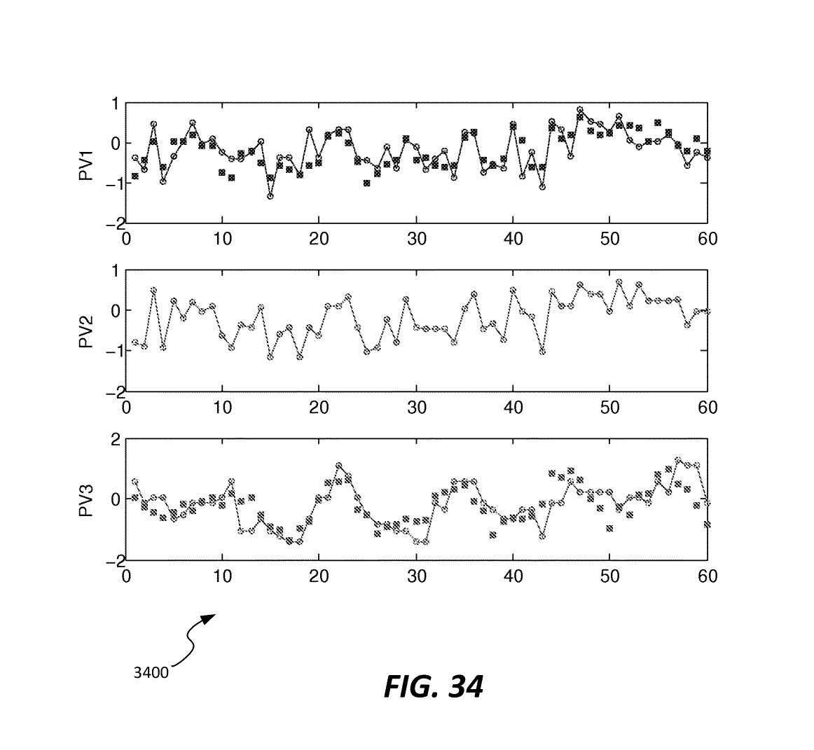

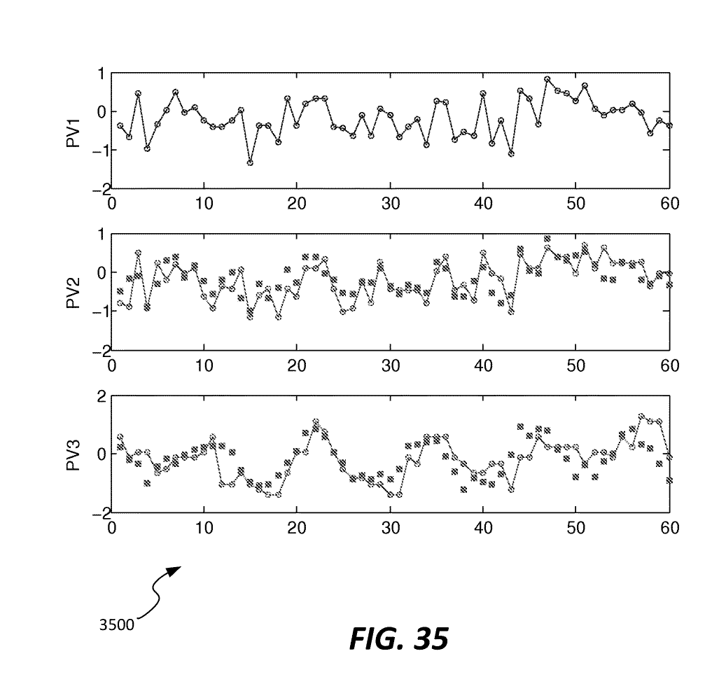

FIGS. 33-35 illustrate charts 3300, 3400, 3500, respectively, for backwards data reconstruction in the event two sensors fail. In particular, chart 3300 of FIG. 33 shows the case where first and second sensors are missing, chart 3400 of FIG. 34 shows the case where first and third sensors are missing, and chart 3500 of FIG. 35 shows the case where second and third sensors are missing. In these cases, mean squared error is calculated as follows:

Sensors 1, 2 Missing: 1.0507

Sensors 1, 3 Missing: 0.3911

Sensors 2, 3 Missing: 0.4680

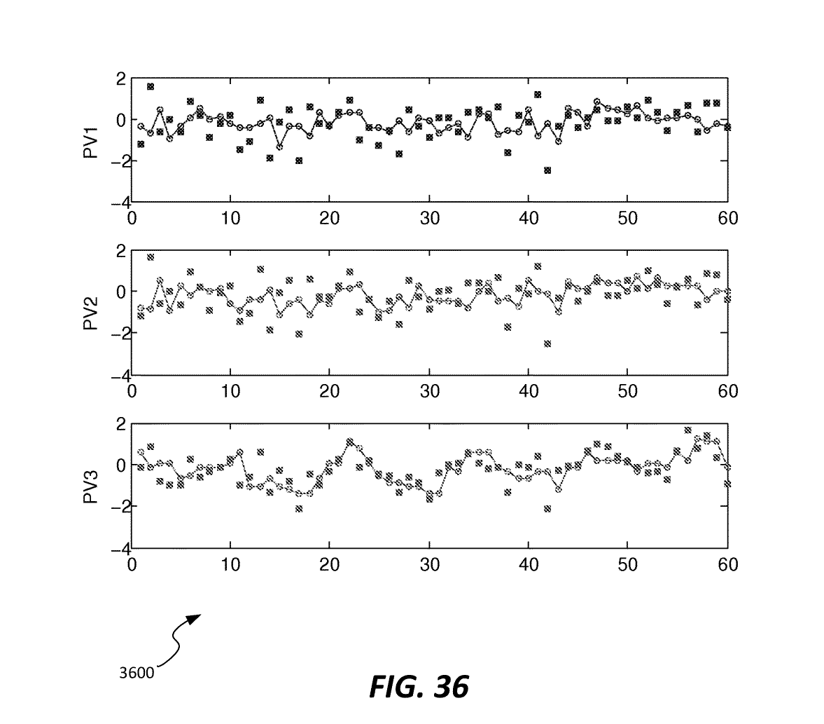

FIG. 36 illustrates a chart 3600 of experimental results for backwards data reconstruction in the event that three sensors are missing. The mean squared error of this reconstruction result is 2.2542.

Referring generally to FIGS. 1-36, it is noted that the systems and methods of the present disclosure provide for a configurable framework in which various operators can be implemented, and in which operators for data reconstruction have been implemented successfully, for reconstructing missing and faulty records. These include forward data reconstruction (FDR) and backward data reconstruction (BDR) approaches. The FDR uses partial data available at a particular time along with the past data to reconstruct the missing or faulty data. The BDR uses partial data available at a particular time along with the future data to reconstruct the missing or faulty data. Therefore, the methods implemented in the operators described herein make the best use of information that is available at a particular time. When the initial portion of the data sequence are normal for at least d consecutive time intervals, FDR could be used. If this is not the case, BDR could be used. The application results to the offshore production facility show that our methods could effectively reconstruct missing records not only when parts of the sensors are missing but also when all the sensors are missing.

Referring generally to the systems and methods of FIGS. 1-36, and referring to in particular computing systems embodying the methods and systems of the present disclosure, it is noted that various computing systems can be used to perform the processes disclosed herein. For example, embodiments of the disclosure may be practiced in various types of electrical circuits comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, aspects of the methods described herein can be practiced within a general purpose computer or in any other circuits or systems.

Embodiments of the present disclosure can be implemented as a computer process (method), a computing system, or as an article of manufacture, such as a computer program product or computer readable media. The computer program product may be a computer storage media readable by a computer system and encoding a computer program of instructions for executing a computer process. Accordingly, embodiments of the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media. Further, the disclosed methods′stages may be modified in any manner, including by reordering stages and/or inserting or deleting stages, without departing from the overall concept of the present disclosure.

The above specification, examples and data provide a complete description of the manufacture and use of the composition of the invention. Since many embodiments of the invention can be made without departing from the spirit and scope of the invention, the invention resides in the claims hereinafter appended.

1. A computer-implemented method for reconstructing data, the method comprising:
receiving a selection of one or more input data streams at a data processing framework;
receiving a definition of one or more analytics components at the data processing framework;
applying a dynamic principal component analysis to the one or more input data streams;
detecting a fault in the one or more input data streams based at least in part on a prediction error and a variation in principal component subspace generated based on the dynamic principal component analysis; and
reconstructing data at the fault within the one or more input data streams based on data collected prior to occurrence of the fault.

2. The computer-implemented method of claim 1, wherein reconstructing the data at the fault is further based on partial data at the time of the fault.

3. The computer-implemented method of claim 1, wherein the dynamic principal component analysis relates measured data in one of the one or more input data streams to one or more linear combinations of past data ordered by variance.

4. The computer-implemented method of claim 1, wherein reconstructing the data at the fault includes determining a fault vector representing a difference between the data from the one or more input data streams and a data value representing a minimized squared prediction error.

5. The computer-implemented method of claim 4, further comprising extracting a magnitude of the fault from the data in which the fault occurs, thereby reconstructing the data at the fault.

6. The computer-implemented method of claim 1, wherein the data collected prior to occurrence of the fault includes previously reconstructed data.

7. The computer-implemented method of claim 1, wherein the one or more input data streams comprises a data stream of sensor data from an oil production facility.

8. The computer-implemented method of claim 1, further comprising receiving one or more configuration parameters from a user.

9. The computer-implemented method of claim 1, further comprising receiving one or more threshold settings including a confidence limit used in detecting a fault by comparison to the prediction error.

10. The computer-implemented method of claim 1, wherein applying a dynamic principal component analysis model comprises using a singular value decomposition algorithm.

11. A system comprising:
a user interface presented on a display of a computing system, the user interface configured to receive a defined data processing configuration, the defined data processing configuration including a selection of one or more input data streams and one or more operations;
a data processing framework configured to, based on selection of the one or more operations, apply a dynamic principal component analysis model to the one or more input data streams to detecting faults in the one or more input data streams based at least in part on a prediction error and a variation in principal component subspace generated based on the dynamic principal component analysis;
wherein the data processing framework is further configured to reconstruct data at a fault within the one or more input data streams based on data collected within a predetermined time from occurrence of the fault.

12. The system of claim 11, wherein the data processing framework includes a plurality of analytics modules.

13. The system of claim 12, wherein the analytics modules include an individual analytics module, a temporal group analytics module, a spatial group analytics module, an arbitration analytics module, and a field analytics module.

14. The system of claim 13, wherein the dynamic principal component analysis model is included in the temporal group analytics module.

15. The system of claim 12, wherein the user interface allows a user to define one or more configuration parameters associated with each of the plurality of analytics modules.

16. The system of claim 12, wherein the data processing framework includes a data reconstruction component.

17. The system of claim 16, wherein the data reconstruction component performs at least one of forward data reconstruction and backward data reconstruction.

18. The system of claim 11, wherein the data processing framework is configured to reconstruct data at the fault from the one or more input data streams based at least in part on data collected prior to occurrence of the fault.

19. The system of claim 11, wherein the data processing framework is configured to reconstruct data at the fault from the one or more input data streams based at least in part on data collected after occurrence of the fault.

20. The system of claim 11, wherein the data processing framework is configured to reconstruct data at the fault from the one or more input data streams based at least in part on partial data at the time of the fault.

21. A computer-readable medium having computer-executable instructions stored thereon which, when executed by a computing system, cause the computing system to perform a method for reconstructing data for a dynamic data set having a plurality of data points, the method comprising:
receiving a selection of one or more input data streams at a data processing framework;
receiving a definition of one or more analytics components at the data processing framework;
applying a dynamic principal component analysis to the one or more input data streams;
detecting a fault in the one or more input data streams based at least in part on a prediction error and a variation in principal component subspace generated based on the dynamic principal component analysis; and
reconstructing data at the fault within the one or more input data streams based on data collected prior to occurrence of the fault.

22. The computer-readable medium of claim 21, wherein the dynamic principal component analysis relates measured data in one of the one or more input data streams to one or more linear combinations of past data ordered by variance.

23. The computer-readable medium of claim 21, wherein reconstructing the data includes determining a fault vector representing a difference between the data from the one or more input data streams and a data value representing a minimized squared prediction error.

24. The computer-readable medium of claim 23, further comprising extracting a magnitude of the fault from the data in which the fault occurs, thereby reconstructing the data at the fault.
